(19) United States
(12) Patent Application Publication
(10) Pub. No.: US 2023/0145102 A1
(43) Pub. Date: May 11, 2023

(54) PRODUCTION OF MAGNESIUM OXYCHLORIDE CEMENT BOARDS

(71) Applicant: MITEK HOLDINGS, INC., Wilmington, DE (US)

(72) Inventors: James A. Wambaugh, Houston, TX (US); Nicholas Pagley, Houston, TX (US); Cole Weinberger, Houston, TX (US)

(73) Assignee: MITEK HOLDINGS, INC., Wilmington, DE (US)

(21) Appl. No.: 17/985,631

(22) Filed: Nov. 11, 2022

Related U.S. Application Data
(60) Provisional application No. 63/278,382, filed on Nov. 11, 2021.

(51) Int. Cl. C04B 28/32; C04B 40/00; C04B 22/16

(52) U.S. Cl. CPC C04B 28/32; C04B 40/0046; C04B 40/0082; C04B 22/165; C04B 2111/00612

(57) ABSTRACT

The present invention is directed to processes for making cementitious construction material, in particular magnesium oxychloride (MOC) cementitious construction material (e.g., MOC boards). The processes relate to one or more operations of the overall material production process, including material storage and handling, mixing of materials, curing to form magnesium oxychloride cement, board handling, and/or packaging. Various processes of the present invention involve process control strategies and/or algorithms to provide improved processes for producing construction material. In particular, the processes of the present invention provide improvements in board properties as detailed below (e.g., racking strength), speed of board production, economics of board production, reduction in complexity of manufacture, improvements in consistency of board manufacture, and improvements in quality control.

### FIELD OF THE INVENTION

The present invention is directed to processes for making cementitious construction material, in particular magnesium oxychloride cementitious (MOC) construction material (e.g., MOC boards). The processes relate to one or more operations of the overall material production process, including material storage and handling, mixing and reacting of materials, curing to form magnesium oxychloride construction material, board handling, and/or packaging. Various processes of the present invention involve process control strategies and/or algorithms to provide improved processes for producing construction material. In particular, the processes of the present invention provide improvements in board properties as detailed below (e.g., racking strength), speed of board production, economics of board production, reduction in complexity of manufacture, improvements in consistency of board manufacture, and improvements in quality control.

### BACKGROUND OF THE INVENTION

MOC construction material, including MOC boards are known as alternatives to construction materials such as, for example, Portland cement cementitious board, gypsum board, and oriented strand board (OSB). As compared to these materials, MOC is more environmentally friendly (or a “green”) alternative to such construction materials MOC construction material including boards have been prepared and are known in the art. Based on their materials of construction, one advantage of MOC boards is their light weight and ease of handling (cutting, nailing) compared to other cementitious boards. For indoor use, MOC boards can be advantageous based on their being resistant to rotting, mold, termites, and bacteria due to their inorganic nature. MOC boards are also fire-resistant, non-combustible and can be manufactured without the use of crystalline silica.

Although MOC boards may provide one or more of these properties or advantages, commercial MOC boards are have been known to suffer from one or more performance characteristics that prevent their widespread adoption for use as construction material due to poorly produced boards with low quality control. One common limitation of MOC boards that are not made to exact recipe and curing specifications during commercial scale production is their instability in the presence of water after installation or when subjected to warm water stability testing as described herein. Another issue with poorly produced MOC boards is the presence of excess free chlorides, which can result in corrosion of other construction materials and fasteners (e.g., nails and screws).

In addition to certain board features or characteristics, there have been issues associated with consistent quality manufacturing of MOC boards on a commercial scale. Although suitable boards, or groups of boards may be prepared there have been issues associated with commercial manufacture over a significant period of time in terms of productivity (e.g., speed of manufacture) and quality control. Because of the inadequacy of known production processes, MOC boards historically have had wide variation in crucial characteristics. As a result, processes and plants for MOC board production often created boards with poor structural qualities and inadequate or poor water resistance. Thus, known systems and processes for MOC board production often created MOC boards that failed to have the very qualities that make MOC boards desirable in construction. For example, where adopted for use on a commercial scale, MOC boards have been observed to suffer from one or more disadvantages, including leaching of chlorides from boards, resulting in corrosion of fittings used to install the boards. See, for example, Hansen et al., “MAGNESIUM-OXIDE BOARDS CAUSE MOISTURE DAMAGE INSIDE FACADES IN NEW DANISH BUILDINGS” 22-24 Aug. 2016, International RILEM Conference on Materials, Systems and Structures in Civil Engineering, Technical University of Denmark, Lyngby, Denmark, 11 pages.

Other commercial scale manufacture has resulted in poor quality cured magnesium oxychloride material, which may result in inadequate strength characteristics. In particular, one indicator of suitable material is the proportion of “5-phase” material (detailed elsewhere herein) present in the final cementitious material. Prior commercial manufacturing operations have been observed to provide magnesium oxychloride containing too little 5-phase material as originally prepared and even less after storage for a time under certain conditions (e.g., enhanced temperature and moisture conditions). It is currently believed that the ambient temperature and humidity conditions of MOC manufacture may contribute to forming this poor material.

For example, prior batch operations have been observed to take up to twenty-four hours of processing time, or more, per batch. Significant variation in conditions (e.g., temperature and humidity) may be observed over such a period of time, therefore, there may be wide variations in batch-to-batch conditions, which can result in wide variations in product quality, consistency in properties from board-to-board and from one production run to the next. The processes of the present invention avoid these lengthy processing times and, thereby avoid issues associated with variation in batch-to-batch conditions.

Moreover, certain commercial operations have been observed to require over two weeks of total curing time (e.g., up to 17 days or greater), whereas total processing times for the present processes, including curing, is significantly shorter (e.g., 12 hours or less or even four hours or less). As with lengthy processing times, wide variations in curing conditions, product quality, product consistency, etc. have been observed in connection with such lengthy curing times. Simply terminating the curing process prematurely does not address these issues. That is, terminating the curing process would not provide an acceptable MOC board, perhaps of less quality, but would simply not provide any suitable material. Unless the curing process is allowed to proceed to completion, which in current commercial scale operations has been observed to be quite lengthy as noted above, suitable material is not provided. The processes of the present invention avoid such lengthy curing times and, therefore, their attendant issues.

The need exists, therefore, for MOC boards exhibiting suitable properties such as those discussed above, including water stability, low chloride leaching, ease of handling, resistance to mold, termites, and bacteria, fire-resistance and non-combustibility.

The need exists, therefore, for improved MOC boards with consistent and enhanced individual performance characteristics of the boards (e.g., improved racking strength) and for improved systems and processes for the commercial manufacture of MOC boards with such consistent and enhanced individual performance characteristics.

### BRIEF SUMMARY OF THE INVENTION

Briefly, therefore, the present invention is directed to, processes for making a cementitious construction material.

One aspect of the present invention is directed to a process for making a magnesium oxychloride cementitious construction material. The process comprises mixing and reacting a source of magnesium chloride brine with a source of magnesium oxide in a premixer, thereby forming a magnesium oxychloride cement premix; transferring the magnesium oxychloride cement premix to a mixer; mixing the magnesium oxychloride cement premix with an aggregate in the mixer, thereby forming a magnesium oxychloride concrete mixture; forming the magnesium oxychloride concrete mixture into a plurality of boards on a plurality of supports; conveying the plurality of supports with the boards thereon through a curing oven, the curing oven comprising an entrance, an exit and a plurality of curing zones therebetween through which the supports with the boards thereon are conveyed, each curing zone having one or more curing air inlets and one or more curing air outlets through which curing air is circulated in contact with the boards when conveyed through the zone, wherein as the boards are conveyed through the curing zones, the magnesium oxychloride mixture of the boards is cured to form magnesium oxychloride crystals and generate exothermic heat within one or more of the curing zones; and transferring at least a portion of the exothermic heat generated in one or more of the curing zones to one or more curing zones upstream of the one or more of the curing zones from which the exothermic heat is transferred.

Another aspect of the present invention is directed to a process for making a magnesium oxychloride cementitious construction material. The process comprises mixing and reacting a source of magnesium chloride brine with a source of magnesium oxide in a premixer, thereby forming a magnesium oxychloride cement premix; transferring the magnesium oxychloride cement premix to a mixer; mixing the magnesium oxychloride cement premix with an aggregate in the mixer, thereby forming a magnesium oxychloride concrete mixture; forming the magnesium oxychloride concrete mixture into a plurality of boards on a plurality of supports; and conveying the plurality of supports with the boards thereon through a curing oven, the curing oven comprising an entrance, an exit and a plurality of curing zones therebetween through which the supports with the boards thereon are conveyed, each curing zone having one or more curing air inlets and one or more curing air outlets through which curing air is circulated in contact with the boards when conveyed through the zone. As the boards are conveyed through the curing zones the magnesium oxychloride mixture of the boards is cured to form magnesium oxychloride crystals and the time required for each board to pass through the curing oven (i.e., residence time) and the temperature and humidity of the curing air are controlled such that boards exiting the curing oven: comprise 5-phase magnesium oxychloride having the formula Mg₃(OH)₅Cl·4H₂O in a concentration of at least about 65 wt %, at least about 70 wt %, at least about 72 wt %, at least about 74 wt %, at least about 76 wt %, at least about 78 wt %, at least about 80 wt %, at least about 82 wt %, at least about 84 wt %, at least about 86 wt %, at least about 88 wt %, or at least about 90 wt % as determined by X-Ray Diffraction (XRD); and/or exhibit a flexural strength of at least about 5 MPa, at least about 6 MPa, at least about 10 MPa, or at least about 16 MPa; and/or a specific flexural strength of at least about 6 MPa/(g/cm³), at least about 10 MPa/(g/cm³), at least about 15 MPa/(g/cm³), or at least about 20 MPa/(g/cm³).

Further aspects of the present invention are directed to processes for making a magnesium oxychloride cementitious construction material comprising mixing and reacting a source of magnesium chloride brine with a source of magnesium oxide in a premixer, thereby forming a magnesium oxychloride cement premix; transferring the magnesium oxychloride cement premix to a mixer; mixing the magnesium oxychloride cement premix with an aggregate in the mixer, thereby forming a magnesium oxychloride concrete mixture; continuously forming the magnesium oxychloride concrete mixture into a planar mass of the desired dimensions for board production onto a plurality of supports and cutting the planar mass into boards of the desired length; and continuously conveying the supports with the boards thereon through a curing oven, the curing oven comprising an entrance, an exit and a plurality of curing zones therebetween through which the supports with the boards thereon are conveyed, each curing zone having one or more curing air inlets and one or more curing air outlets through which curing air is circulated in contact with the boards when conveyed through the zone, wherein as the boards are conveyed through the curing zones, the magnesium oxychloride mixture of the boards is cured to form magnesium oxychloride crystals.

Another aspect of the present invention is directed to a magnesium oxychloride cementitious construction material. The material comprises magnesium oxychloride crystals and is in the form of a board having a first surface generally parallel to a second surface; and at least one weather-resistant barrier layer on at least one of the surfaces thereof.

One aspect of the present invention is directed to a magnesium oxychloride cementitious construction material, wherein the construction material is characterized by one or more of the following properties: density of at least about 0.5 g/mL, at least about 0.6 g/mL, at least about 0.7 g/mL, from about 0.5 to about 1.5 g/mL, or from about 0.6 to about 1.4 g/m; and/or racking strength ranging from 400 pounds per linear foot (“plf”) to 600 plf, determined according to ASTM E72-13A; and/or flexural strength of at least about 5 MPa, at least about 6 MPa, at least about 10 MPa, or at least about 16 MPa; and/or specific flexural strength of at least about 6 MPa/(g/cm³), at least about 10 MPa/(g/cm³), at least about 15 MPa/(g/cm³), or at least about 20 MPa/(g/cm³); and/or lateral screw pull thickness of at least about 150 lbf/inch at least about 200 lbf/inch, at least about 250 lbf/inch, at least about 300 lbf/inch, at least about 350 lbf/inch, at least about 400 lbf/inch, at least about 450 lbf/inch, at least about 500 lbf/inch, at least about 550 lbf/inch, or at least about 600 lbf/inch; and/or specific lateral screw pull thicknesses of at least about 150 lbf/in/(g/cm³), at least about 200 lbf/in/(g/cm³), at least about 250 lbf/in/(g/cm³), at least about 300 lbf/in/(g/cm³), at least about 350 lbf/in/(g/cm³), at least about 400 lbf/in/(g/cm³), at least about 450 lbf/in/(g/cm³), at least about 500 lbf/in/(g/cm³), at least about 550 lbf/in/(g/cm³), at least about 600 lbf/in/(g/cm³), at least about 650 lbf/in/(g/cm³), at least about 700 lbf/in/(g/cm³), at least about 750 lbf/in/(g/cm³), or at least about 800 lbf/inch/(g/cm³); and/or an impact strength demonstrated by no damage as determined by a falling ball (typically having a weight of approximately 532 grams) impact test, using a twelve-inch drop as determined by ASTM D1037; and/or a compression strength (Fc) of at least about 1800 PSI, or a compression strength (Fc) of from about 1800 PSI to about 2200 PSI; and/or a compression indentation depth of less than about 2.5 millimeters (mm) (e.g., less than 1.3 mm or less than about 1 mm) at a pressure least about 1250 PSI, or at a pressure of from about 1500 PSI to about 3000 PSI, as determined by ASTM D2394; and/or a nail head pull through of at least about 90 pounds force (“lbf”), or from about 150 lbf to about 300 lbf, as determined by ASTM D1037; and/or a screw pull through of at least about 175 pounds force (“lbf”), or from about 175 lbf to about 350 lbf, as determined by ASTM D1037; and/or a thermal linear expansion of less than about 0.25%, or from about 0.01% to 0.25%, as determined by ASTM E228; and/or a moisture linear expansion of less than about 0.25%, or from about 0.01% to 0.25%, as determined by ASTM C1185; and/or a moisture stability exhibited by stability in water at about 60° C. for from about 24 hours to about 56 days using a Warm Water Stability Test as authenticated by Clemson University Chemical Engineering Department in 2017; and/or a metal corrosiveness, as evidenced by AWPAE12-94 fastener corrosion testing, measured in mills per year, of 5 mills per year to 30 mills per year, or less than 35 mills per year; and/or meeting the noncombustibility requirements of ASTM E136 (Standard Test Method for Assessing Combustibility of Materials Using a Vertical Tube Furnace at 750° C., as defined in the 2012, 2015 and 2018 IBC Model Codes); and/or a vapor permeability of about 8 to about 30 Perm; and/or a resistance to seismic impact for earthquakes over 3.1; and/or a seismic rating or force displacement curve that does not include a sharp peak; and/or maintenance of at least about 70% (at least 70%) of strength at a displacement of about 2.5 inches according to ASTM E72.

Other objects and features will be in part apparent and in part pointed out hereinafter.

### BRIEF DESCRIPTION OF THE SEVERAL VIEWS OF THE DRAWING

FIG. 1 depicts an overall schematic of a production line of the present invention.

FIG. 2 depicts a schematic for preparing a cement premix and concrete mixture for curing to form MOC cementitious material.

FIG. 3 depicts a schematic of a process for handling supports carrying MOC concrete material for forming construction material (e.g., boards).

FIG. 4 depicts a schematic of a process for transferring supports carrying MOC concrete material for curing.

FIG. 5 is a schematic depicting a curing zone/oven for use in a process of the present invention.

FIG. 6 depicts an overhead schematic view of a curing oven used in accordance with an embodiment of the present invention.

FIG. 7 depicts a schematic of the curing oven depicted in FIG. 6 as viewed from the entrance of the curing oven.

FIGS. 8 and 9 depict process control strategies for preparing a cement premix and delivering to a mixer using one premix tank and two premix tanks, respectively.

FIG. 10 provides representative plots indicating the variation in performance target(s), including flexural strength and MOC efficacy, during board production for prior art processes and processes of the present invention.

Corresponding reference characters indicate corresponding parts throughout the drawings.

### DETAILED DESCRIPTION OF THE INVENTION

Preparation of MOC cementitious construction materials generally involves combining and reacting magnesium oxide starting material and magnesium chloride starting material (e.g., magnesium chloride brine) to form a cement premix of these components; combining other desired components (e.g., aggregate(s) and/or additive(s)) with the premix; mixing the premix and aggregates and/or additives together to form a wet concrete mixture; forming the wet concrete mixture into a planar mass of the desired dimensions for board production; and transferring or conveying the formed concrete mixture to an oven for curing for a time sufficient to form the MOC cementitious construction material exhibiting the features detailed herein.

MOC is a crystalline ceramic material suitable for use as a structural construction material, including boards. It is desired for MOC for structural applications, or at least a significant portion thereof to have the stoichiometric formula Mg₃(OH)₅Cl.4H₂O, which is known as “5-phase” MOC. Various aspects of the present invention relate to achieving the desired molar ratio, on an active ingredient basis, between magnesium oxide, magnesium chloride, and water in order to form the 5-phase MOC, in particular achieving a molar ratio of 5:1:13 (MgO:MgCl₂:H₂O) for these components during the production process. Achieving this ratio, which may involve adjusting the formulations accordingly during production, is important to provide MOC having one or more of the desired properties listed herein. Various strategies and processes detailed herein relate to achieving this molar ratio in the mixture cured to form the MOC construction material. These include various strategies and process controls related to forming the premix, including controlling its density and controlling its temperature during preparation. These strategies also relate to control of the amounts of individual starting materials and their physical characteristics, their total amounts used, and the composition of the resulting premix.

The MOC of the construction material typically includes 5-phase MOC and a plurality of crystals. During preparation of the MOC, typically an amorphous phase cementitious material is formed from mixing of the starting materials, and typically incorporating a stabilizing material including phosphorous acid and/or phosphoric acid as detailed elsewhere herein. Typically, a portion of the amorphous phase cementitious material grows a plurality of crystals, the crystals typically having a molecular weight (MW) within the range of 280 to 709, the amorphous phase cementitious material encapsulating the plurality of crystals, wherein a majority of stabilizing material with a phosphorus-containing compound are consumed into a nano-molecular veneer while increasing surface area of the plurality of crystals during curing (e.g., surface area increases of from 2% to 49% during curing have been observed), and wherein the nano-molecular elements of the cured nano-molecular veneer are insoluble in water and the cured nano-molecular veneer protects the plurality of crystals from degradation in water at temperatures from 20° C. to 60° C. (from 68° F. to 140° F.) for from 24 hours to 56 days of the formed cementitious material. MOC of the present invention generally is in the form described in U.S. Pat. Nos. 10,167,230; 10,167,231; 10,167,232; and 10,227,259, the entire contents of which are incorporated by reference herein for all relevant purposes.

Various other aspects of the present invention relate to the exothermic nature of the reaction between magnesium oxide and magnesium chloride and control systems and strategies related thereto. These strategies include usage of the heat generated during the reaction in the cure oven for heating the material to be cured and maintenance and/or control of the moisture conditions of the cure environment.

Although the following discussion focuses on magnesium oxychloride cement (MOC), the present processes are also suitable for preparing magnesium oxysulfate cement (MOS). Such processes typically proceed in accordance with the following discussion, but via a reaction between magnesium oxide and a magnesium sulfate solution.

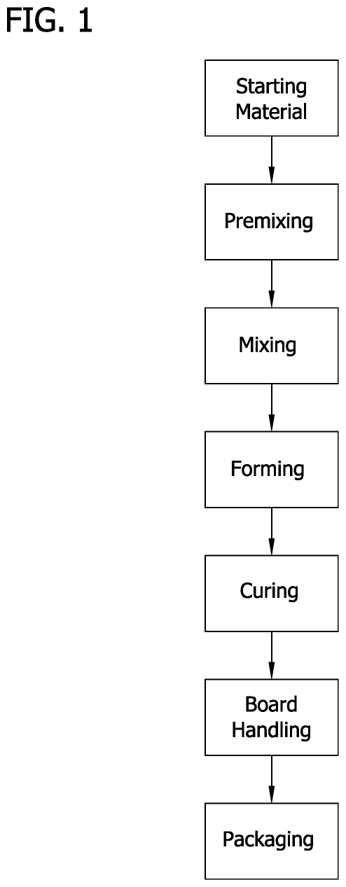

FIG. 1 provides a block-flow diagram of an overall process for the manufacture of MOC boards, including the portions related to the starting material, premixing, mixing, forming, curing, board handling, and packaging. These sections will be discussed in more detail below, individually and in combination.

The present invention involves improved processes for the manufacture of MOC cementitious construction materials including MOC cementitious boards that exhibit one or more improvements including, for example, improved water stability (in particular, warm water stability), improved fire resistance (e.g., meeting non-combustibility requirements), and improved racking strength. Processes of the present invention have provided MOC material containing significantly higher proportions of 5-phase material, both during preparation and after storage or testing under certain conditions. Advantageously, the processes of the present invention provide improved boards based on these features on both an absolute, or bulk basis and also on a specific basis (i.e., per unit mass basis).

The present invention also provides processes that produce MOC construction material and boards on a commercial scale at a consistent rate; with minimal variation in these properties (e.g., a minimum percentage meeting the set quality control standards); and/or at a significant increase in speed of production (e.g., reducing the time for production of a commercial lot from days to hours). For example, manufacturing processes of the present invention are able to produce boards at relatively high rates in terms of linear feet per second (e.g., greater than about 20 linear feet/s, greater than about 25 linear feet/s, greater than about 30 linear feet/s, greater than about 35 linear feet/s, greater than about 40 linear feet/s, greater than about 45 linear feet/s, greater than about 50 linear feet/s, or even greater than about 60 linear feet/s). In addition to achieving advantageous rates of production, the manufacturing processes of the present invention are also able to achieve these rates of production while providing low variability in performance properties over the course of a batch or production run (e.g., less than 10% variation or lower), in particular the performance properties detailed elsewhere herein (e.g., flexural strength).

Again with reference to FIG. 1 are listed the following operations/activities included in the processes: Starting Material; Premixing; Mixing; Forming; Curing; Board Handling; and Packaging. As detailed below, there are various advantageous features of these individual processes including, for example, the magnesium oxide starting material utilized. There are also various advantageous processes involving combinations of these individual processes including for example, adjusting the curing conditions based on the features of the starting material and/or features of the cured MOC cement.

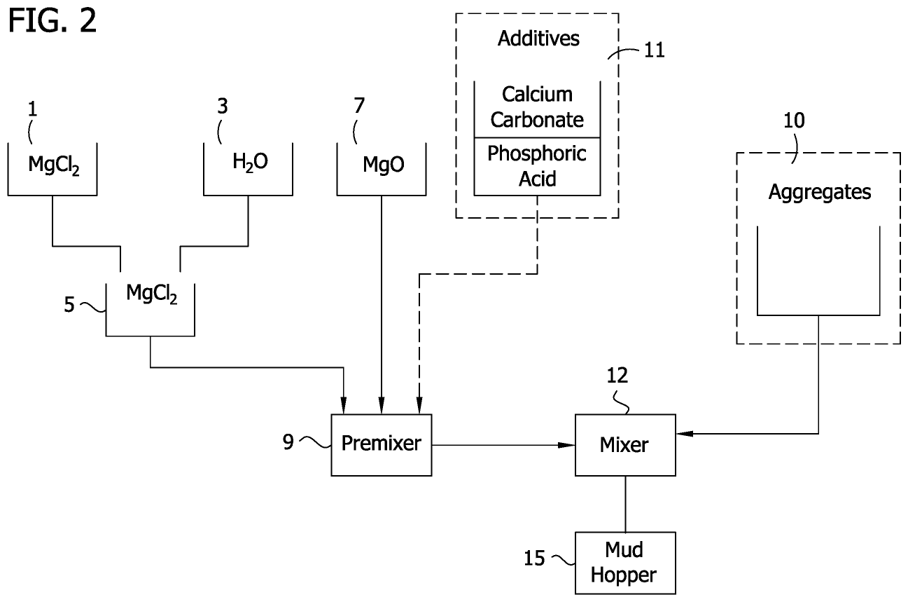

FIG. 2 depicts various steps of processes of the present invention that provide a mixture for curing to form MOC construction material. Generally, with reference to FIG. 2, magnesium chloride starting material (brine) and magnesium oxide (MgO) starting material are stored in vessels 5 and 7, respectively, and each introduced into premixer vessel/reactor 9. As noted above, a signal consideration of the processes of the invention is providing 5-phase MOC cement (i.e., MOC containing MgO:MgCl₂:H₂O at a molar ratio of 5:1:13, on an active ingredient basis, respectively), an important aspect of which involves the amounts and proportions of starting materials. In large-scale operations, this molar ratio is achieved by monitoring and controlling the amounts and proportions of starting material used to form the cement premix in the premixer vessel prior to introduction into the main mixer to be combined with aggregates and/or other additives.

### Magnesium Chloride

The magnesium chloride starting material is in the form of a magnesium chloride in water mixture, or solution. Typically, the mixture, referred to herein as brine, contains from about 20 wt % to about 30 wt % magnesium chloride in water.

Achieving 5-phase MOC is controlled by selecting the relative proportions of starting materials used to form the cement premix. In accordance with the present invention, the magnesium chloride brine provides two of the three reaction constituents, water and magnesium chloride salt, with the magnesium oxide providing the other reaction constituent. Achieving 5-phase MOC typically begins with establishing a desired molar ratio for the magnesium chloride and water in the brine. Typically, the magnesium chloride starting material (i.e., brine) is prepared to provide a molar ratio of magnesium chloride, on an active ingredient basis, in water of about 1:13. This molar ratio is achieved by monitoring the properties of the magnesium chloride brine, premix, etc. and adjusting the concentration of their components accordingly. Depending on the precise composition of the final product, curing conditions, etc. there can be some variation in the amount of water used. For example, while 1:13 is the target molar ratio of magnesium chloride to water, there can be an excess of water, for example, up to an approximately 10% molar excess of water to magnesium chloride. For example, the molar ratio of magnesium chloride to water may be from about 1:13 to about 1:14.2, or from about 1:13 to about 1:13.5.

In particular, the density of the magnesium chloride brine is monitored and controlled to ensure the correct and desired amount of magnesium chloride and water are delivered to the premixer vessel. The density of the magnesium chloride is monitored using a continuous density control meter on the brine makeup tank, vessel 5 shown in FIG. 2.

Typically, a target density may be used as the set-point for the desired 1:13 molar ratio of the magnesium chloride brine solution. In various embodiments, the target brine density is at least about 1.15 g/mL (e.g., at least about 1.20 g/mL, at least about 1.25 g/mL, or at least about 1.28 g/mL). Often, the density of the magnesium chloride brine is from about 1.15 g/mL to about 1.30 g/mL, or from about 1.17 g/mL to about 1.30 g/mL. In order for the brine density to more accurately correspond to a desired molar ratio of the magnesium chloride brine solution, highly pure magnesium chloride may be used.

If the brine density deviates from the desired set-point, thereby indicating a deviation from the desired molar ratio of magnesium chloride to water, the concentration of magnesium chloride and/or water is adjusted. To adjust the molar ratio, additional magnesium chloride and/or water may be added to magnesium chloride brine vessel 5, from vessels 1 (magnesium chloride) and/or 3 (water), respectively, as shown in FIG. 2.

Typically, where the density is above the target, additional water is added to the brine. Conversely, where the target density is below the target, additional magnesium chloride is added to the brine.

Sources of additional magnesium chloride include stock magnesium chloride brine, and solid magnesium chloride flake. In certain embodiments, the source of magnesium chloride is a pure magnesium chloride. Sources of additional water for the brine include general makeup water and recovered process water.

Again with reference to FIG. 2, vessel 3 provides water for combining with a source of magnesium chloride 1 (e.g., stock magnesium chloride solution or solid magnesium chloride flakes) to provide magnesium chloride brine to be stored in a vessel 5. In certain embodiments, the predominant and often primary source of the brine water is process water obtained from a suitable source (e.g., municipal water). In these and certain other embodiments, a portion of the brine water may be recovered from elsewhere in the process (i.e., recovered process water).

Points of recovery for the process water include wash water from the premixer, wash water from the mixer, and the wash water used for cleaning the main line that conveys the mixture from the mixer to the curing oven (as detailed elsewhere herein and not shown in FIG. 2). Regardless of its point of recovery, the recovered process water may be transferred from the recovery point to the water source for the magnesium chloride brine (e.g., vessel 3 in FIG. 2) and/or to the magnesium brine vessel (e.g., vessel 5 in FIG. 2) via suitable piping or conduits (not shown in FIG. 2). Typically, the recovered process water is filtered prior to combining with the initial, or fresh water source.

Separately, or along with density, the temperature of the magnesium chloride brine is also controlled and maintained to provide a brine of the desired composition. The temperature of the brine is monitored by a temperature sensor connected to the brine storage vessel and via a flow meter following a heat exchanger through which the brine passes. If needed, heat (not shown in FIG. 2) may be introduced or extracted from the brine into the brine storage vessel via a heating/cooling jacket on the storage vessel (day tank) or using the heat exchanger.

Typically, the temperature of the magnesium chloride brine is maintained at a temperature of at least about 20° C. (about 68° F.), at least about 30° C. (about 86° F.), or at least about 40° C. (about 104° F.). Often, the temperature of the magnesium chloride brine is from about 20° C. (about 68° F.) to about 60° C. (about 140° F.), or from about 30° C. (about 86° F.) to about 50° C. (about 122° F.).

Given the possibility of corrosion over time, the magnesium chloride brine is typically stored in a corrosion-resistant vessel. As noted, typically the vessel is also equipped with a sensor for monitoring the density, temperature sensor(s), and apparatus for adjusting the temperature of magnesium chloride brine.

### Magnesium Oxide

Again with reference to FIG. 2, the magnesium oxide starting material is stored in vessel 7 and is a particulate in powder form having a magnesium oxide content of at least about 80 wt %, or from about 80 wt % to about 98 wt % for combining with the magnesium chloride brine from vessel 5 in the premixer vessel 9. In various embodiments, the magnesium oxide has a surface area ranging from 5 m²/g to 150 m²/g, as measured by Brunauer-Emmett-Teller (BET), and an average particle size ranging from about 0.3 to about 90 microns wherein more than about 90% by weight magnesium oxide particles are less than or equal to about 40 microns, as determined by the sieve method.

Typically, in certain embodiments, the BET surface area of the magnesium oxide is from about 10 m²/g to about 120 m²/g, from about 10 m²/g to about 100 m²/g, from about 10 m²/g to about 80 m²/g, from about 10 m²/g to about 60 m²/g, from about 10 m²/g to 40 m²/g, from about 20 m²/g to about 40 m²/g, from about 20 m²/g to about 30 m²/g, or from about 25 m²/g to about 30 m²/g. In certain embodiments, the magnesium oxide starting material has a BET surface area of from about 5 m²/g to about 50 m²/g.

As discussed above, the magnesium chloride brine provides two components of the reaction while the magnesium oxide provides the third, with the magnesium chloride brine containing magnesium chloride and water at a molar ratio, on an active ingredient basis, of approximately 1:13 and typically a ratio of 1:13, respectively. The proportion of magnesium oxide combined with the magnesium chloride brine is selected to achieve MOC cement (and MOC concrete upon combining the cement with the other additives, or ingredients such as aggregates) having 5-phase MOC. Generally, a suitable proportion of magnesium oxide is combined with the brine to provide such 5-phase material. In accordance with the present invention it has been discovered there are advantages to having the magnesium chloride component as the limiting variable in the reaction to form 5-phase material. These advantages include, for example, reduced free chlorides that could leach from the cementitious material and thus free chlorides available that could rust metal fasteners. To address this problem, an excess of MgO over that required to provide the precise 5:1:13 molar ratio listed above is utilized.

Accordingly, typically the proportion of magnesium oxide added is suitable to provide a molar ratio, on an active ingredient basis, of MgO:MgCl₂ H₂O of >5:1:13. Typically, the excess of magnesium oxide introduced into the premix provides a molar ratio for MgO in excess of 5:1:13. For example, typically, the MgO molar ratio provided is at least about 5.1:1:13, at least about 5.2:1:13, or even at least about 5.3:1:13. Stated alternatively, the MgO is at least about 2%, at least about 4%, or at least about 6% in excess of the proportion required to provide an overall molar ratio of 5:1:13 (on a weight or molar basis).

Along with the strategies detailed above employed to provide the magnesium chloride brine of the desired composition, density, etc., there are process control strategies developed to ensure a proper amount of magnesium oxide is introduced into the premixer.

For example, as detailed below, the results of quantitative X-ray diffraction (XRD) are used to determine properties of finished MOC construction material (e.g., boards) and adjustments in preparation of the premix may be made, as necessary, based on these results. In addition, free chlorides identified during moisture testing of finished boards may also indicate the need to adjust the proportions of starting material. A relatively high proportion of free chlorides can call for a reduction in the amount of magnesium chloride introduced into the premixer (either by diluting the brine or using less brine) or by increasing the proportion of magnesium oxide.

Since the relative proportions of the components of the premix are important to ensure the premix is suitable for forming 5-phase MOC, strategies are employed to confirm the desired proportions of all components utilized to form the premix. In particular, the amounts of the starting materials are measured multiple times, typically in terms of double redundancies and, where possible, triple redundancies.

For example, generally the amounts of magnesium oxide starting material and magnesium chloride starting material are determined, typically using a loss-in-weight scale associated with the respective storage vessel identifying the mass removed for the dry materials (e.g., vessel 7 containing magnesium oxide shown in FIG. 2) and identifying the flow rates removed for liquid components (e.g., vessel 5 containing magnesium chloride brine shown in FIG. 2).

With respect to the solid materials used in the premix as measured by the loss-in-weight raw material scales, the material is also added to a pre-weigh hopper(s) prior to being introduced into the mixer. Along with these amounts, the amount of the premix in the premixer vessel is monitored, typically continuously using a weigh cell associated with the premixer vessel. Accordingly, the amounts of solid materials are monitored via triple redundancy by determining the amount removed from the storage vessel, determining the amount of materials passed through the pre-weigh hopper prior to introduction into the premixer vessel, and by differentially determining the amount of solids from the total weight of material introduced into the premixer vessel less the weight of magnesium chloride solution. Similarly, the amounts of liquid materials are determined via a double redundancy by monitoring the flow rate of the liquid materials removed from their storage vessels and monitoring the total amount/flow rates of material introduced into the premixer vessel.

As mentioned above, the present process notably involves the magnesium chloride brine delivering two constituents of the reaction (the water and the chloride) with its density adjusted to the proper density so that when the brine is delivered to the premixer vessel, it is providing the correct amount of both water and magnesium chloride salt. This is conducted using a continuous density control meter on the brine makeup tank (i.e., vessel 5 shown in FIG. 2). This makeup tank also controls the temperature the magnesium chloride brine prior to its introduction to the premixer vessel.

Generally, the loss-in-weight scales, premixer vessel, and weigh cell are equipped with suitable apparatus and controlling machinery and instrumentation in order to compare the amounts of the starting material and total premix and adjust as necessary. Typically, the sum of the amounts is compared to the weight of premix in the premixer vessel, with this comparing conducted continuously including, for example, using a weigh cell to continuously measure the weight of premix in the premixer vessel.

Typically, a desired weight of premix in the premixer vessel is established as a set-point. The weight of premix in the vessel is continuously determined and compared to the set-point and, if necessary, the weight of premix is adjusted. For example, the weight of premix in the mixer can be adjusted in response to a deviation in the weight of premix from the set-point by adjusting the weight the magnesium oxide starting material removed from its storage vessel and/or the weight of the magnesium chloride brine removed from its storage vessel. Additionally, or alternatively, the weight of premix may be adjusted by removal of premix from the premixer vessel.

### Aggregates and Additives

Generally, the processes of the present invention involve combining one or more aggregate(s) materials, typically solid, and one or more additive(s), typically liquid with the cement premix. The aggregate(s) or additive(s) may be combined with the components of the cement premix prior to its introduction into the mixer or the aggregate(s)/additive(s) may be combined separately from the premix components and then combined with the cement premix in the main mixer.

Again with reference to FIG. 2, aggregate(s) material is stored in one or more containers (e.g., shown as 10 in FIG. 2). Suitable aggregate(s) are selected from the group consisting of wood fiber, perlite, polystyrene foam beads, carbon fiber, glass fiber, polymer fiber, natural fiber, and calcium carbonate powder. These components are generally referred to by these generic terms, but may serve one or more particular functions. For example, perlite serves as a non-combustible light-weight component, wood fiber serves to improve ductility, fibrous fillers are added to improve strength (e.g., lateral screw pull, and screw pull through), and expanded polystyrene (EPS) serves as light-weight component.

The MOC construction material may contain any or all of the various components and exhibit any or all of the desired properties of the cementitious construction material described in co-pending U.S. application Ser. No. 17/817,313, filed Aug. 3, 2022 entitled CEMENTITIOUS CONSTRUCTION MATERIAL CONTAINING MAGNESIUM OXYCHLORIDE CRYSTALS, the entire contents of which are hereby incorporated by reference for all relevant purposes. The cementitious construction material described therein includes carbon fibers. Separately or along with the carbon fibers as described therein, the MOC of the present invention may include one or more “aggregates” as mentioned above, including wood, perlite, polystyrene foam beads, glass fiber, polymer fiber, natural fiber, calcium carbonate, or recycled magnesium oxychloride. Any or all of these components can be incorporated into the cementitious material of the present invention.

Other suitable aggregates, which may be termed reinforcing material, may also be added to the cementitious material. The reinforcing material may be incorporated in a proportion of from about 0.1 wt % to about 25 wt %, or from about 0.1 wt % to about 15 wt % of the cementitious material. Suitable reinforcing material can be a non-woven or woven silica containing mat, a non-woven, or woven hydrocarbon containing mat.

Fibrous reinforcing material can also be chopped silica containing fibers; hemp containing fibers; carbon fiber strands; chopped carbon fibers (generally or in accordance with the above-referenced co-pending U.S. application); chopped hydrocarbon fiber; and combinations thereof. Such fibrous material is typically incorporated in a proportion of less than about 5% of the cementitious material.

The cementitious construction material can include at least one surfactant or polymer added to the amorphous phase to decrease porosity of aggregates and prevent amorphous phase from entering pores of the aggregates.

The surfactants and polymers can be any molecule that reduces the surface porosity of the aggregates being used in the cement.

Further in accordance with the present invention, it has been discovered that incorporation of a siliconate as a surfactant into the cementitious material of the present invention can be advantageous. Generally, the siliconate is an organic modified alkali silicate of the formula R—SiO₃⁻M⁺, wherein R is an organic moiety and M is an alkali metal cation. In certain embodiments, R may be an organic moiety selected from the group consisting of a substituted or unsubstituted alkyl, alkenyl, cycloalkyl, aryl, heteroaryl, heterocycle, or arylalkyl. In some embodiments M⁺ may be selected from the group consisting of lithium, sodium, potassium, rubidium, cesium, and francium. In certain embodiments, M⁺ is sodium or potassium.

In certain embodiments of the present invention, the siliconate is an alkali metal organosiliconate such as an alkali metal alkylsiliconate or alkali metal phenylsiliconate. For example, the siliconate is selected from the group consisting of sodium methylsiliconate, sodium ethylsiliconate, sodium propylsiliconate, potassium methylsiliconate, potassium ethylsiliconate, potassium propylsiliconate, sodium phenylsiliconate, sodium benzylsiliconate, potassium phenylsiliconate, potassium benzylsiliconate, and combinations thereof. In certain embodiments, the siliconate is selected from the group consisting of sodium methylsiliconate, sodium ethylsiliconate, potassium methylsiliconate, potassium ethylsiliconate, and combinations thereof. In still further embodiments, the siliconate may be selected from sodium trimethyl siliconate or potassium trimethyl siliconate. In various embodiments, the alkali metal is potassium siliconate (e.g., potassium methyl siliconate, SiO₃CH₃K₃).

Non-limiting examples of suitable siliconates include XIAMETER OFS-0777 Siliconate, XIAMETER OFS-0772 Siliconate (commercially available from Dow Silicones Corporation) and mixtures thereof.

In various embodiments, the siliconate is incorporated along with a stabilizing material, but without carbon fibers being incorporated. In still other embodiments, the siliconate is incorporated along with a stabilizing material and carbon fibers. Typically, the siliconate is added to the mixer along with the premix.

Generally, the siliconate is incorporated in accordance with the processes described above regarding incorporation of carbon fibers and stabilizing material. It has been observed that incorporating a siliconate provides advantages in terms of the final properties of the construction material. For example, it has been observed that the presence of the siliconate functions as a porosity/pore volume and/or density modifying component. That is, it has been observed that incorporating a siliconate component provides a final cementitious construction material having a high porosity/pore volume and/or lower density as compared to a cementitious construction material prepared without incorporating a siliconate. Advantageously, the increase in porosity/pore volume and/or reduction in density are not accompanied by any sacrifice in structural strength or performance properties of the siliconate-containing cementitious construction material. The advantages of the presence of a siliconate are independent of incorporating carbon fibers but, advantageously, may also be combined with the advantages of incorporating carbon fibers. Typically, the siliconate is incorporated as part of treated carbon fibers.

Additive(s), typically liquid that serve one or more functions, may also be added to the MOC material. Such additives are typically stored in one or more container(s) (e.g., shown as 11 in FIG. 2), from which these materials are removed and combined with the premix prior to introduction into mixer 15.

One such additive is calcium carbonate, which serves as a non-combustible mineral filler material and may be incorporated in solid (e.g., powder) form.

Again with reference to FIG. 2., a phosphorus-containing stabilizing material (e.g., phosphoric acid and/or phosphorous acid) may be introduced into the premix from vessel 11.

Generally, the stabilizing material comprises phosphorous acid (H₃PO₃) and/or phosphoric acid (H₃PO₄). Suitable stabilizing material includes aqueous solutions containing at least about 40 wt %, at least about 45 wt %, from about 40 wt % to about 70 wt % or from about 40 wt % to about 65 wt % of a concentrate of H₃PO₃. Other suitable stabilizing material includes aqueous solutions containing from about 40 wt % to about 90 wt %, or from about 50 wt % to about 80 wt % of a concentrate of H₃PO₄.

Typically, stabilizing material is introduced in a proportion of from about 0.1 wt % to about 10 wt %, based on the final total weight of the cementitious material and is introduced into the cement premix shortly before the cement premix is transferred from premixer vessel 9 to the main mixer 12.

Following addition of the stabilizing material (i.e., phosphorus-containing compound) to the liquid mixture in premixer vessel 9, the liquid suspension is allowed to react with the stabilizing material. Generally, the liquid suspension is allowed to react with the stabilizing material for a period of time from about 1 minute to about 10 minutes, or from about 1 minute to about 4 minutes.

As detailed herein, during subsequent curing of the cementitious material magnesium oxychloride crystals are formed. During this curing, the phosphorus-containing stabilizing material is consumed into a nano-molecular veneer, which increases the surface area of the magnesium oxychloride crystals, typically by from about 2% to about 49%. The nano-molecular elements of the cured nano-molecular veneer are insoluble in water and the cured nano-molecular veneer protects the magnesium oxychloride crystals from degradation. For example, the cured nano-molecular veneer has been observed to protect the crystals of the formed cementitious material from degradation in water at temperatures from about 20° C. to about 60° C. for from about 24 hours to about 56 days.

Typically, the amount of aggregate(s) and additive(s) combined with the premix is determined using loss-in-weight scales associated with the one or more vessels containing aggregate to be introduced into the premix. After introduction of the aggregate(s) thereto, the total amount of premix is determined and compared to a desired set-point.

Depending on the results of this comparison, the total amount of pre-mix may be adjusted by addition of magnesium oxide starting material, magnesium chloride brine, and/or one or more aggregate(s) thereto.

Again with reference to FIG. 2, material may be transferred from the premixer vessel 9 to the main mixer 12 via pumping apparatus, where necessary. For example, where the mixer is arranged above the premixer vessel such as in height-constrained environments. Alternatively, the premixer vessel may be arranged above the mixer vertically and the premix may be introduced into mixer under the flow of gravity (e.g., by pouring or dumping).

Following introduction of the cement premix into the main mixer 12, the mixture is blended for an appropriate mixing time. The mixing time is typically at least about two minutes, at least about five minutes and more typically from about two minutes to about eight minutes. Preferred mixing times may vary depending upon conditions of the blend and blending including, for example, the composition and design of the mixing blade, the speed of the mixing, and the composition of the premix and mixture. Generally, the mixer comprises a housing; a plurality of horizontal paddles; and a driver for moving the paddles.

Overall, the components of the MOC concrete are the magnesium oxide, magnesium chloride, water and the aggregate(s) or other additives. Various aspects of the present invention involve continuously monitoring and determining the amounts of these components removed from their respective storage vessels and the amounts of the mixture(s) provided by their combination. For example, in certain embodiments, the sum of the amounts of magnesium oxide and magnesium chloride removed from their respective storage vessels is continuously compared to the weight of premix in the premixer vessel. Such methods also involve continuously monitoring the individual amounts of magnesium oxide and magnesium chloride removed from their respective storage vessels. These methods further include, if necessary, optionally adjusting the weight of premix by addition of magnesium oxide and/or magnesium chloride brine thereto. The methods further include determining the amounts of these individual components, their combined mixture, comparing these amounts to set-point and making adjustments, as necessary.

The methods further require monitoring and controlling the proportion of aggregate(s) introduced into the premix in the same manner. Specifically, mixing the premix in the premixer for a mixing period, thereby forming a magnesium oxychloride mixture, wherein the process further comprises continuously monitoring the amount of magnesium oxychloride mixture in the premixer, and optionally adjusting the weight of the mixture in response to a deviation from a set-point by addition of magnesium oxide, magnesium chloride, and/or one or more aggregates thereto. For example, such methods typically involve determining the amount of aggregate removed from its respective storage vessel, monitoring this individual amount and the total amount of aggregate, continuously monitoring this total amount of premix, and making adjustment to one or more components of the premix based on the comparison to the desired set-point.

Further, the mixing the premix in the premixer for a mixing period, thereby forming a magnesium oxychloride mixture, wherein the process further comprises continuously monitoring the amount of magnesium oxychloride mixture in the mixer, and optionally adjusting the weight of the mixture in response to a deviation from a set-point by addition of magnesium oxide, magnesium chloride, and/or one or more aggregates thereto.

### Continuous Operation

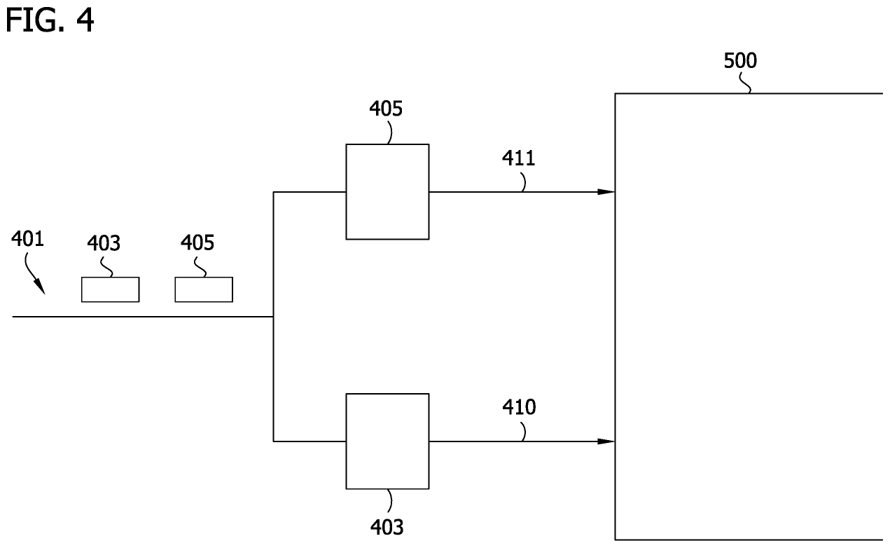

Again with reference to FIG. 2, following main mixer 12 the production line includes vessel 15 (e.g., a mud hopper) including or in fluid flow communication with an extruder. The wet concrete mixture (i.e., a magnesium oxychloride cement mixture comprising aggregates) passes through the extruder and is formed into a planar mass of the desired dimensions for board production on a support (e.g., carrier tray or mold) and sent to the curing zone within a curing oven. Details regarding the curing oven and the one or more curing zones contained therein are provided elsewhere herein (e.g., See FIGS. 4-7).

The MOC mixture from the mixer is collected from the mixer and passed, or conveyed to vessel 15. As described herein, vessel 15 may be termed a holding vessel, or mud hopper. Although vessel 15 may be termed a holding vessel, its function is not limited to simply collecting MOC mixture from the mixer, but also serves the purpose of controlling the amount of mixture sent to the cure oven. The holding vessel/mud hopper includes or is in flow communication with an extruder 21. In certain embodiments, the holding vessel/mud hopper and extruder are a single piece of equipment with the mud hopper receiving the MOC mixture and passing the mixture along to the extruder.

To provide suitable efficiencies and productivities on a commercial scale, production processes incorporating one or more aspects of the invention defined herein are conducted as continuous processes. The continuous processes generally, therefore, involve blending particulate magnesium oxide starting material and magnesium chloride brine starting material in the form of a magnesium chloride solution in a premixer comprising one or more paddles for mixing the starting materials; mixing the premix in the premixer for a mixing period, thereby reacting the starting materials and forming a magnesium oxychloride cement mixture; removing the magnesium oxychloride cement mixture from the premixer; conveying the premix to a main mixer to be combined with aggregates and/or additives and mixed therein for a specified mixing period to form an MOC concrete mixture; transferring the MOC concrete mixture to the mud hopper; continuously extruding the MOC concrete mixture into a planar mass of the desired dimensions for board production onto supports; and continuously conveying the extruded concrete mixture on the supports into a curing zone within a curing oven; and continuously heating the mixture within the oven, thereby forming a cementitious construction material comprising magnesium oxychloride crystals. Preparation of the premix and the MOC concrete mixture may be batchwise or continuous and are staged and controlled such that as the mud hopper empties, additional MOC concrete mixture is available and transferred to the mud hopper to allow for the continuous extrusion of the mixture onto supports and the continuous curing of the formed MOC concrete mixture to produce the cementitious construction material comprising magnesium oxychloride crystals in the form of a board.

Again with reference to FIG. 2, continuously conveying the mixture to the curing zone including an oven involves holding vessel (mud hopper) 15 and passing the mixture from the holding vessel to the curing zone involves transferring the concrete mixture from the holding vessel onto one or more supports, which typically includes passing the MOC concrete mixture through an extruder connected to or in direct fluid flow communication with the mud hopper. Accordingly, continuous operation of the present invention involves continuously passing the MOC concrete mixture from the holding vessel to the curing oven, typically involving continuously transferring a portion of the MOC concrete mixture from the holding vessel through an extruder and onto one or more supports (e.g., a carrier tray or mold). The ability to operate the curing oven to provide commercial production within reduced time periods as compared to the prior art (e.g., less than about 8 hours, less than about 6 hours, or about 4 hours) is a significant feature in allowing for continuous operation.

One aspect of continuous operation of the production processes of the present invention involves operation of the holding vessel. Generally, the capacity of the holding vessel exceeds the capacity of the mixer. In this manner, premix cement can be continuously prepared, mixed in the mixer with aggregates to form a concrete mixture, and collected in the holding vessel. Likewise, MOC concrete mixture can be continuously removed from the holding vessel for conveying to the ovens, and collection of finished boards.

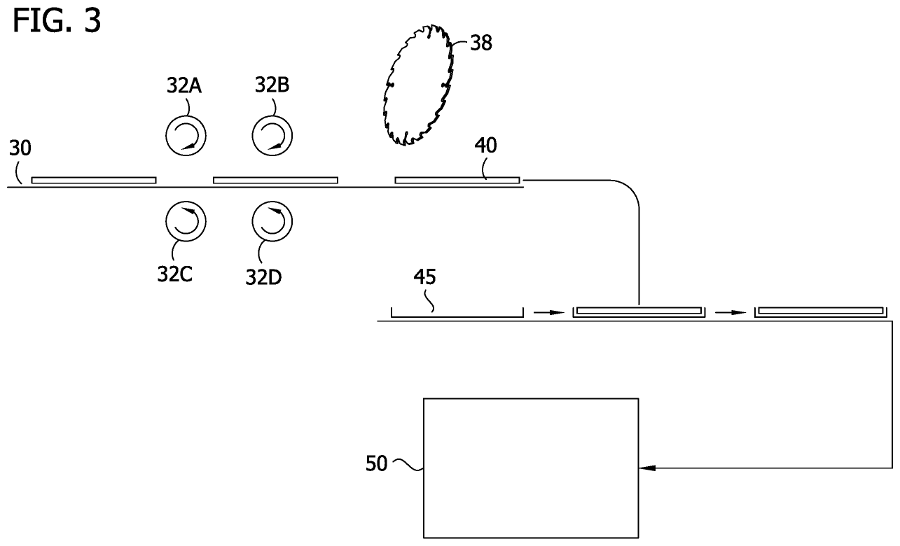

Following mixing, holding in the holding vessel, and passage through an extruder, MOC concrete material for curing to form final structural material is passed to means for conveying the material along the production line. With reference to FIG. 3, the output from mixing zone of FIG. 1 is passed to conveying means 30 where one or more layers may be combined with the cementitious construction material. FIG. 3 depicts four rollers (32A-32D), two for applying a layer to each side the construction material. However, it is to be understood that myriad arrangements of layers on either side of the construction material are suitable in accordance with the present invention. Typically, however, at least one layer is applied to the cementitious construction material. In various embodiments, the present invention involves first applying a polyethylene layer, followed by a fiberglass layer, onto which the construction material is placed, with a fiberglass layer then applied to the construction material, followed by a polyethylene layer applied to the fiberglass layer. In other embodiments, the present invention involves first applying a polypropylene layer, followed by a fiberglass layer, onto which the construction material is placed, with a fiberglass layer then applied to the construction material, followed by a polypropylene layer applied to the fiberglass layer. In still further embodiments, the present invention involves first applying a polyester layer, followed by a fiberglass layer, onto which the construction material is placed, with a fiberglass layer then applied to the construction material, followed by a polyester layer applied to the fiberglass layer. In various embodiments, the cementitious construction material may have at least one layer selected from the group consisting of a polyethylene layer, polypropylene layer, or polyester layer.

In various embodiments, it is to be understood the cementitious layer can be combined with a single layer such as a permeable or non-permeable membrane that does not require any adhesive to form an integrated laminate material with the cementitious material. Avoiding the need for an adhesive provides advantages in terms of process efficiencies, costs, etc.

In various embodiments, the construction material is combined with three separate layers. A first layer, either directly in contact with the cementitious material without an adhesive or secured to the cementitious material with an adhesive, is polyethylene (e.g., non-woven polyethylene), polypropylene, polyester, or combinations thereof. Following this layer typically a weather-resistant barrier layer is added. Suitable weather resistant barrier layers may be characterized by being liquid water repellent, and either water vapor permeable or non-permeable depending upon the desired quality in the board application. In certain embodiments, the weather resistant barrier layer comprises polyethylene, polypropylene, polyester, or combinations thereof. Following this layer, and forming an outside layer may be included a durability layer. The durability layer may be polyethylene, polypropylene, polyester, or combinations thereof. Regardless of the precise arrangement of layers of materials and MOC material, conveying means 30 passes the material to a slicing apparatus 38 that results in discrete portions of MOC material (plus any additional layers), 40. As shown in FIG. 3, each portion of MOC material 40 is then collected on a support 45 and sent to a curing zone (identified as 50 in FIG. 3).

In other embodiments, a magnesium oxychloride cementitious construction material in the form of a board is prepared by a process comprising preparing a wet magnesium oxychloride mixture; forming the wet magnesium oxychloride mixture into a board; and contacting a weather-resistant barrier material with the wet magnesium oxychloride mixture, thereby forming a weather-resistant barrier layer on at least one of the surfaces of the board. In some embodiments, the process may comprise depositing the wet magnesium oxychloride mixture directly onto a weather-resistant barrier material and forming the wet magnesium oxychloride mixture into a board, thereby forming the weather-resistant barrier layer on the bottom surface of the board. In other embodiments, the weather-resistant barrier material be arranged such that a weather-resistant barrier layer is formed on the top of the board.

As detailed above, recovered process water may be utilized to form the magnesium chloride brine. In various embodiments, this recovered process water is generated along the conveying means for passing the MOC mixture from the mixer and mud hopper along the line for adding one or more layers of the MOC to provide supports having MOC concrete thereon for curing.

Again with reference to FIG. 1, the output from mixing zone is directed to a forming step in which the MOC concrete material is formed into a planar mass of the desired dimensions for board production onto a plurality of supports and cut to the desired length. The supports carrying the boards are subsequently transferred to one or more curing zones within the curing oven for curing to form the final cementitious construction material (e.g., boards).

In the forming step of FIG. 1, the MOC concrete material contained on the one or more supports is formed into a cementitious construction material for curing (i.e., in the shape of a board). The forming step may comprise any step necessary to achieve the desired dimension(s) of the MOC concrete material contained on the one or more supports. In certain embodiments, the forming step may comprise a device for ensuring a consistent thickness of the MOC concrete material contained on the one or more supports. For example, the supports may pass along a conveyor belt wherein a sizing device is positioned at a certain height to scrape off excess MOC concrete material from the support and achieve a desired thickness of the MOC concrete material. A roller may be used to set desired thickness and provide relatively uniform and flat major surfaces of the MOC concrete material. In further embodiments, the supports may pass along a conveyer belt that comprises one or more sizing devices on the sides of the supports. The one or more sizing devices on the sides of the supports may be configured to remove excess MOC concrete material and achieve a desired width or length of the MOC concrete material. Still further, certain embodiments may comprise a cutting device for cutting the MOC concrete material to a desired length. For example, the supports may pass along a conveyer belt wherein a saw cuts the MOC concrete material to a predetermined length by cutting at the front and/or back of the MOC concrete material as it travels along the conveyer belt.

The forming step may be configured to prepare a MOC concrete material contained on the one or more supports having desired dimensions. These dimension may be selected to be similar to dimensions corresponding to those of commercially available plywood, drywall and similar conventional construction materials. In other embodiments, the dimensions are selected such that after subsequent curing and finishing a cementitious construction material may be recovered having dimensions corresponding to those of commercially available plywood, drywall and similar conventional construction materials. For example, the MOC concrete material may have lengths ranging from about 3 feet to about 10 feet, widths from about 3 feet to about 5 feet, and thicknesses of up to 1.5 inches.

One issue surrounding prior processes for preparing MOC cementitious construction material was the inability to operate on a commercially feasible scale on a continuous basis. The processes of the present invention allow for operating continuously on a commercially feasible scale in terms of output per building footprint. Although various strategies reported herein are currently believed to contribute to this advantageous output, the most significant driver is the ability to operate at curing times significantly lower than prior processes. Prior commercial processes typically operated the curing portion of the process for extended periods, often taking in total days, or even weeks. The processes of the present invention are able to produce effective boards on a commercial scale while the curing step is operated for less than about 8 hours, or less than about 6 hours (e.g., about 4 hours).

As shown in FIG. 4, conveyor 401 transfers MOC supports 403 and 405 where the supports are (optionally) rotated 90 degrees following passage by conveyors 410 and 411, respectively, into curing zone 500. It is to be understood, however, that re-orienting of the supports while entering the curing zone is not critical from a perspective of curing to form the final MOC cement. This is depicted as an option where there could be constraints in terms of space, or overall footprint of the production line requiring such re-orienting.

### Dynamic Oven

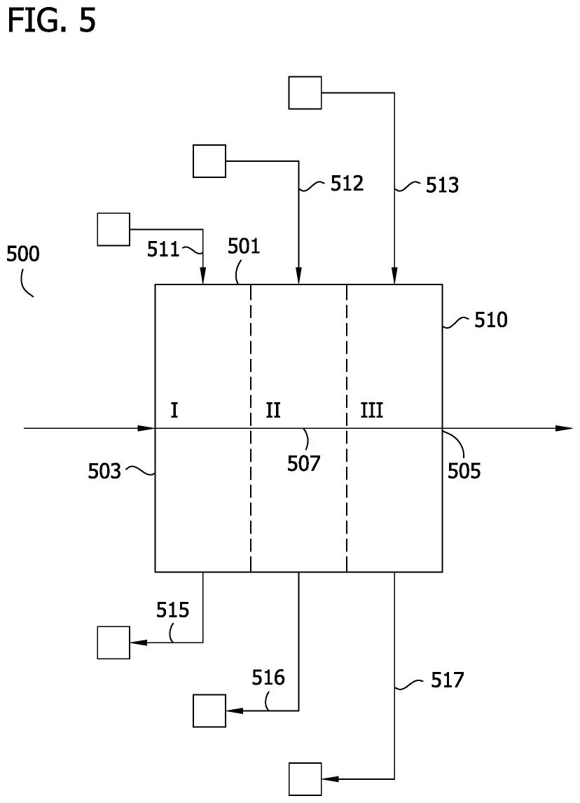

With reference to FIG. 5 depicting curing zone 500, curing oven 501 includes first (I), second (II), and third (III) zones. Generally, within zone I the MOC mixture is heated from its entry temperature to a suitable curing temperature, within zone II the MOC mixture is exposed to and held at the desired curing temperature for a suitable curing time, followed by cooling of the cured MOC in zone III. Although the three zone are identified as discrete zones for description purposes, they are not physically separated such that MOC mixture may be present within more than one zone and may be undergoing one or more the above effects while present within a single zone or more than one zone.

Overall, passage of material through the cure oven involves continuous movement in order to reduce and preferably the avoid the risk of uneven heating of the material that could be caused by trapped heat within the zone. Such trapped heat could be caused by an exothermic event occurring during the curing operation, with the greatest risk of this occurrence being in the zone (II) where all, or substantially all of the curing of the concrete material occurs.

In certain embodiments, although the temperature is desired to be roughly constant throughout the curing oven, the exothermic reaction of curing the MOC mixture increases the temperature of the board as the curing progresses. In this embodiment, the temperature within the curing zones may increase as the material passes through the oven. That is, the temperature within the second zone is higher than the temperature within the first zone, and the temperature within the third curing zone is higher than the temperature within the second curing zone.

As noted, the primary purpose of the first curing zone is heating of the concrete mixture to, or very near the desired curing temperature. As noted above, various strategies of the present invention involve temperature control between the premix, its components, and the temperature of the first curing zone. Typically, the temperature within the first curing zone is less than about 80° C. (about 180° F.), for example, from about 65° C. (about 150° F.) to about 80° C. (about 180° F.).

Within the second curing zone, the cementitious material is exposed to temperature conditions that result in curing of the cementitious material to form the MOC construction material. The temperature within the second curing zone is typically less than about 60° C. (about 140° F.), for example, from about 60° C. (about 140° F.) to about 50° C. (about 120° F.).

The third curing zone cools the cured cementitious material to a temperature suitable for handling. The temperature within the third curing zone is typically less than about 48° C. (about 120° F.).

A limitation of curing temperatures is the temperatures the supports carrying the cementitious material are able to withstand. In certain embodiments, the curing temperature is maintained below a maximum temperature of about 165° F., about 160° F., about 155° F., about 150° F., about 145° F., or about 140° F.

Curing—Temperature Control

As detailed elsewhere herein, in accordance with the present invention the formed, MOC concrete mixture (i.e., MOC cement comprising further additives such as aggregates) is introduced into a curing zone comprising a curing oven and associated apparatus. Such apparatus can include, for example, temperature sensors, humidity sensors, processors, etc.

Prior to introduction into the curing oven, the MOC concrete mixture is typically held within and passed through a holding vessel (e.g., mud hopper 15 in FIG. 2). Typically, an important parameter is the temperature difference between the MOC concrete mixture removed from the mixer and/or held in the holding vessel before introduction into the curing oven and the initial temperature of the curing oven (e.g., the temperature within a first zone of a plurality of zones of the curing oven).

In certain embodiments, the curing oven comprises a plurality of curing zones, wherein the heat and/or humidity of each curing zone may be independently controlled. The heat of each of the plurality of curing zones may be controlled, for example, by one or more curing air inlets and one or more curing air outlets located in each curing zone. In certain embodiments, the curing air supply inlets are present on a surface of the curing oven opposite of the surface on which the corresponding curing air return outlets are present. In one embodiment, the individual curing zones comprise the space of the curing oven between corresponding curing air inlets and curing air outlets present on opposite sides of the curing oven.

In one embodiment, a plurality of supports or carrier trays having the boards thereon may be supported horizontally on a rack and vertically-spaced from one another such that no support is in contact with another support. The rack is conveyed along a path from the entrance of the curing oven to the exit of the curing oven through the plurality of curing zones along the path. Each curing zone of the curing oven comprises a number of inlets (and corresponding outlets) equal to or greater than the number of supports with boards thereon present on the rack.

In certain embodiments, the orientation of the curing air inlets and outlets alternate as the boards travel through the oven. This configuration allows for the curing air to be continuously circulated and in contact with the boards when they are conveyed through the curing zones of the oven. By alternating the inlet and outlet orientation among the one or more curing zones, a nearly uniform heat and humidity profile across all boards in given curing zone can be achieved.

In some embodiments, the inlets are positioned such that at least each inlet is directly pointed at a board present on the rack at substantially the same elevation within the curing oven. This configuration allows heated curing air to contact and circulate around each of the boards of the curing rack. In this configuration, the heat profile across all boards of a rack for a given curing zone can be even further controlled to be substantially uniform.

In still further embodiments, at least a portion of the curing air introduced into a curing zone originates from heat withdrawn from a downstream curing zone (i.e., a curing zone at the mid-point and/or close to the outlet of the curing oven). The curing of a magnesium oxychloride mixture is an exothermic process. In certain embodiments, it may be desirable to withdraw exothermic heat from the respective curing zone(s). For example, the supports containing the boards or other materials present within the curing oven may begin to melt or degrade if the heat within a curing zone reaches a certain value. Additionally, the curing process may be negatively impacted if the one or more curing zones are too hot and water is allowed to evaporate before it reacts as part of the curing process. In order to maintain the integrity of the curing oven and various components therein (i.e., the supports having the concrete mixture thereon), as well as the curing reaction stoichiometry, in some embodiments a portion of the exothermic heat generated in one or more of the curing zones is transferred to one or more curing zones upstream of the one or more of the curing zones from which the exothermic heat is transferred. In such embodiments, the transferred exothermic heat is advantageously used to provide at least a portion of the activation energy required to form magnesium oxychloride crystals during curing of the magnesium oxychloride mixture of the boards being conveyed through the curing oven in the upstream curing zones). By providing exothermic heat to an upstream curing zone, the external energy requirement (e.g., gas burners to prepare heated air) of that curing zone can be reduced. The transfer of exothermic heat (e.g., heated air) to an upstream curing zone may be introduced through one or more of the curing air inlets to the upstream curing zone.

As shown in FIG. 5, the curing oven includes an inlet 503, outlet 505, and means 507 for conveying the cementitious construction material along a path from the inlet of the oven to the outlet of the oven. During travel along this path, various aspects of the present invention involve monitoring, controlling, and/or adjusting of the temperature within the curing oven, in particular, within the particular curing zones.

Although not shown in FIG. 5, the oven, in particular the individual curing zones include temperature sensors for monitoring the temperature within the curing oven. The sensors are connected and in communication with suitable controllers and processors for maintaining and adjusting the temperature conditions within the curing oven and individual zones.

Again with reference to FIG. 5, the housing of the oven 510 includes conduits 511, 512, and 513 in communication with inlets for introduction of heat into the zones of the oven. Similarly, the housing of the oven 510 includes conduits 515, 516, and 517 in communication with outlets for removal of heat from the oven and, more specifically, one or more of the curing zones.

As discussed elsewhere herein, the reaction between magnesium oxide and magnesium chloride is exothermic. In certain embodiments/aspects of the present invention, the process includes recovery of the exothermic heat of reaction, which avoids excess heating, uneven heating, etc. and also allows for recovery and use of this heat to heat the concrete material in the first zone.

Another improvement of the processes of the present invention, in particular the curing process, is a reduction in the energy usage per unit output of material. This improvement is attributed to a variety of features including, for example, having temperature of the mixture introduced into the oven relatively close to the temperature of the first curing zone, limited variation in temperature throughout the curing zones and therefore less waste, use of the heat from the exotherm of the curing process, and/or a relatively low maximum curing temperature required.

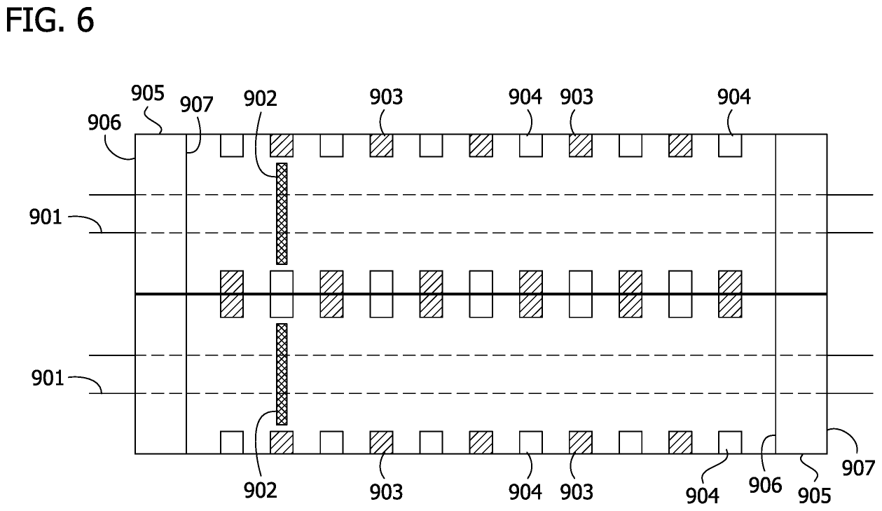

Another embodiment of the curing oven is shown in FIG. 6. FIG. 6 depicts one top-down view of an embodiment of a curing oven comprising two oven sections operating in parallel. Chain conveyers (or “chainveys”) (not shown) convey the racks containing a plurality of supports with the boards thereon along the tracks 901 through the curing oven. Racks 902 containing a plurality of supports with the boards thereon are shown traveling through the curing oven along the track path. For example, the plurality of supports having the boards thereon may be braced horizontally and spaced vertically on a rack, wherein no support is in contact with another support of the plurality of supports having the boards thereon. The rack is conveyed along a path from the entrance of the curing oven to the exit of the curing oven through the plurality of curing zones along the path. The time required for each rack on which the boards are supported to pass through the curing oven (residence time) is controlled by adjusting the speed of the chain conveyors.

The curing oven comprises inlets 903 for the introduction of heated and/or humidified curing air, and outlets 904 for the removal of curing air from the oven. The space between each inlet and outlet may be characterized as an individual curing zones within the oven. FIG. 6 shows 11 curing zones in each oven section operating in parallel.

As illustrated in FIG. 6, the orientation of the inlets and outlets alternate as the boards travel along the tracks through the oven. In this configuration, heated and/or humidified curing air is continually circulated and in contact with the boards when they are conveyed through the curing zones of the oven. This allows for a nearly uniform heat and humidity profile across all boards of a rack at a given curing zone.

As further illustrated in FIG. 6, the curing oven may comprise a vestibule 905 at the inlet and/or outlet. In one embodiment, the inlet comprises a vestibule 905 having two distinct inner and outer doors. In operation, the rack is conveyed along a path towards the entrance of the curing oven, a first outer door 906 opens and the rack proceeds into the vestibule 905, the first outer door 906 closes, a second inner door 907 opens, and the rack proceeds out of the vestibule and into the first curing zone of the curing oven. Similarly, the curing oven may comprise a vestibule 905 at the outlet end of the curing oven with inner and outer doors. For example, a first inner door 906 opens, the rack proceeds out of the final curing zone and into the vestibule 905, the first inner door 906 closes, a second outer door 907 opens, and the rack proceeds out of the vestibule for final processing. Operation in this manner (i.e., with a vestibule at the inlet and/or outlet) allows for a greater degree of control of the temperature and/or humidity of the curing zones. In particular, heat loss from the first curing zone to the external environment can be minimized and result in a more uniform temperature and/or humidity profile within the first curing zone.

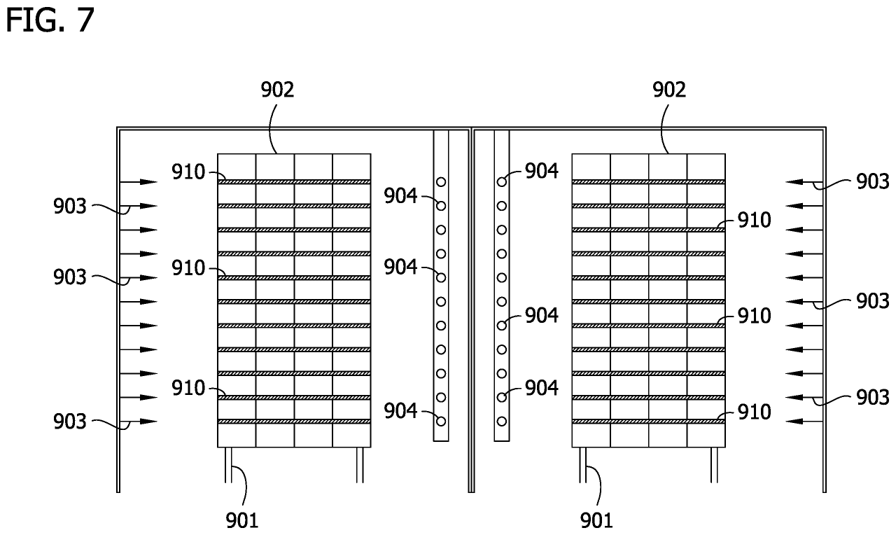

FIG. 7 illustrates an additional view of the embodiment of FIG. 6. FIG. 7 depicts racks 902 containing a plurality of supports 910 with the boards thereon as they enter the curing oven of FIG. 6. As noted in FIG. 6, parallel tracks 901 convey the racks carrying a plurality of supports with the boards thereon through the curing oven.

As the boards travel through the curing oven, the racks are present in one or more curing zones (i.e., between inlets 903 for the introduction of heated and/or humidified curing air and outlets 904 for the removal of curing air from the oven).

FIG. 7 illustrates an embodiment wherein the inlets 903 are positioned such that at least each inlet is directly pointed at a board present on the rack at substantially the same elevation within the curing oven. Each curing zone of the curing oven comprises a number of inlets (and corresponding outlets) equal to the number of supports with boards thereon present on the rack 902. In this configuration, the heat and humidity profile across all boards of a rack, for a given curing zone, can be even further controlled to be substantially uniform. Although only one curing zone is shown in FIG. 7, it will be understood that the same configuration of inlets may be present in each curing zone of the curing oven. As noted in FIG. 6, the location of the inlets within the curing zone (i.e., on the left or right side) may be alternated to further improve the airflow and heat and humidity profile at the surface of the boards.

By directing heated and/or humidified curing air from an inlet that is at substantially the same elevation within the curing oven as the board, it can be ensured that the heated and/or humidified curing air contacts and circulates around each of the boards of the curing rack. In this manner, a more uniform and consistent cementitious construction material can be achieved at the outlet of the curing oven.

Not shown in FIGS. 6 and 7 is the optional recycle of heated air from a curing zone downstream (i.e., right) to a different upstream curing zone upstream with respect to the travel of boards through the oven (i.e., to the left). As discussed elsewhere herein, the curing of a magnesium oxychloride mixture is an exothermic process. However, it is necessary to achieve a certain activation energy to begin the crystallization (i.e., curing) process. In one embodiment of the present disclosure, at least a portion of the exothermic heat generated in one or more of the curing zones is transferred to one or more curing zones upstream of the one or more of the curing zones from which the exothermic heat is transferred. This transfer of heat provides at least a portion of the activation energy required to form magnesium oxychloride crystals during curing of the magnesium oxychloride mixture of the boards being conveyed through the curing oven. In one embodiment, the exothermic heat is transferred to an upstream curing zone by recirculating the heated curing air removed from through the outlets 904 of one or more downstream curing zones and introducing it through one or more of the inlets 903 in the upstream curing zone(s).

In certain embodiments, the temperature within the first curing zone (i.e., the curing zone closest to the inlet of the oven) is no more than about 165° F., no more than about 160° F., no more than about 155° F., no more than about 150° F., no more than about 145° F., no more than about 140° F., no more than about 135° F., no more than about 130° F., no more than about 125° F., no more than about 120° F., no more than about 115° F., no more than about 110° F., no more than about 105° F., or no more than about 100° F. In other embodiments, the temperature within the first curing zone (i.e., the curing zone closest to the inlet of the oven) is from about 100° F. to about 165° F., from about 100° F. to about 160° F., from about 100° F. to about 155° F., from about 100° F. to about 150° F., from about 100° F. to about 145° F., from about 100° F. to about 140° F., from about 100° F. to about 135° F., from about 100° F. to about 130° F., from about 100° F. to about 125° F., from about 100° F. to about 120° F., from about 105° F. to about 120° F., or from about 110° F. to about 120° F.

In certain embodiments, the premix temperature and initial curing temperature (i.e., temperature within the first curing zone) vary by less than the above-specified amounts and, in certain embodiments, may be nearly the same. For example, in certain embodiments, the initial curing temperature is no more than about 20° C. (about 68° F.), no more than about 10° C. (about 50° F.), no more than about 5° C. (about 40° F.), or no more than about 2° C. (about 35° F.) greater than the temperature of the MOC cement premix. In other embodiments, the initial curing temperature is from about 0° F. to about 65° F., from about 5° F. to about 65° F., from about 5° F. to about 60° F., from about 5° F. to about 55° F., from about 5° F. to about 50° F., from about 5° F. to about 45° F., from about 5° F. to about 40° F., from about 5° F. to about 35° F., from about 5° F. to about 30° F., from about 5° F. to about 25° F., from about 5° F. to about 20° F., from about 5° F. to about 15° F., or from about 5° F. to about 10° F. greater than the temperature of the MOC cement premix.

Typically, the temperature within the first curing zone (i.e., the curing zone closest to the inlet of the oven) is no more than about 20° C. (about 68° F.), no more than about 10° C. (about 50° F.), no more than about 5° C. (about 40° F.), or no more than about 2° C. (about 35° F.) greater than the temperature of the magnesium oxychloride mixture introduced into the holding vessel. In other embodiments, the temperature within the first curing zone is from about 0° F. to about 65° F., from about 5° F. to about 65° F., from about 5° F. to about 60° F., from about 5° F. to about 55° F., from about 5° F. to about 50° F., from about 5° F. to about 45° F., from about 5° F. to about 40° F., from about 5° F. to about 35° F., from about 5° F. to about 30° F., from about 5° F. to about 25° F., from about 5° F. to about 20° F., from about 5° F. to about 15° F., or from about 5° F. to about 10° F. greater than the temperature of the magnesium oxychloride mixture introduced into the holding vessel.

Additionally, or alternatively, the temperature within the first curing zone is no more than 20° C. (about 68° F.), no more than about 10° C. (about 50° F.), no more than about 5° C. (about 40° F.), or no more than about 2° C. (about 35° F.) greater than the temperature of the magnesium oxychloride concrete mixture removed from the mixer. In other embodiments, the temperature within the first curing zone is from about 0° F. to about 65° F., from about 5° F. to about 65° F., from about 5° F. to about 60° F., from about 5° F. to about 55° F., from about 5° F. to about 50° F., from about 5° F. to about 45° F., from about 5° F. to about 40° F., from about 5° F. to about 35° F., from about 5° F. to about 30° F., from about 5° F. to about 25° F., from about 5° F. to about 20° F., from about 5° F. to about 15° F., or from about 5° F. to about 10° F. greater than the temperature of the magnesium oxychloride concrete mixture removed from the mixer.

Operating in any of the above manners can provide advantages in terms of process efficiencies by requiring less heating in the cure oven and, therefore, less overall cure time. These advantages are associated with risks in the event of a process disturbance that renders all or a portion of the production line off-line. Operating at cement premix and MOC concrete mixture temperatures near the initial temperature of the curing oven can result in concrete curing prior to entry into the oven if the production line upstream of the oven is shut down and the concrete mixture near the initial curing oven temperature continues heating to form a concrete-like mass, but before being set on supports. Such an occurrence could result in significant process downtime, therefore, the temperature difference is typically maintained at or near the above noted temperatures (e.g., from about 0° F. to about 65° F., from about 5° F. to about 65° F., from about 5° F. to about 60° F., from about 5° F. to about 55° F., from about 5° F. to about 50° F., from about 5° F. to about 45° F., from about 5° F. to about 40° F., from about 5° F. to about 35° F., from about 5° F. to about 30° F., from about 5° F. to about 25° F., from about 5° F. to about 20° F., from about 5° F. to about 15° F., or from about 5° F. to about 10° F.).

Curing—Humidity Control

Again with reference to FIG. 5, the relative humidity within the cure oven 500, is typically monitored and controlled. The humidity/moisture conditions are important during curing to achieve the desired 5:1:13 stoichiometry to provide the desired 5-phase MOC in the final, cured material. If a sufficient proportion of moisture is not maintained during the curing reaction, the final product of the curing reaction can contain undesired 3-phase MOC.

Typically, the relative humidity of the environment within the cure oven (e.g., within one or more of the plurality of zones) is at least about 40%, at least about 45%, or at least about 50%. Generally, when above any of these limits the relative humidity of the cure oven environment is less than about 70%, less than about 65%, or less than about 60%.

More particularly, typically the moisture/humidity conditions within each of the particular zones is monitored and controlled. For example, a decrease in humidity within a second curing zone has been observed under certain conditions. Decreases in relative humidity of 10% or more have been observed. While the moisture conditions are controlled so the desired 5:1:13 stoichiometry persists, significant decreases in moisture during curing are undesired. Accordingly, in certain aspects of the present invention the moisture/humidity curve within the curing oven is monitored and adjusted to maintain the conditions at desired level. This monitoring and adjusting is conducted using suitable sensors, processors, and controlled associated with the curing oven (not shown in FIG. 5).

As explained above, the curing air inlets and outlets of each curing zone can be configured allow for the curing air to be continuously circulated and in contact with the boards when they are conveyed through the curing zones of the oven. In addition to the curing air providing sufficient heat (i.e., energy) to achieve the necessary activation energy for the curing process, it may also be desirable to control the humidity within each curing zone. If the relative humidity is too low, surrounding air may pull water from the board and negatively impact the chemistry of the curing process. Further, the resulting cured boards may not be level or otherwise in acceptable condition for commercial use. If the relative humidity is too high, water may be absorbed from the surrounding air into the board, creating Mg(OH)₂ and negatively impacting the chemistry of the curing process.

In certain embodiments, the humidity within a curing zone is controlled through the introduction of humidified air into the curing air. Humidified air may be created through any traditional method. For example, in one embodiment, water is atomized to create a humidified air. In certain embodiments, the humidified air is a humidified ambient air. That is, the humidified air represents an increased humidity as compared to the ambient air outside of the curing oven. The humidified air may be combined with the curing air before the curing air enters the curing zone through the inlets. In some embodiment, the curing air that is directed through every inlet of the curing zone comprises humidified air. In other embodiments, only the curing air that is directed through some of the inlets of the curing zone comprises humidified air. For example, in a curing zone comprising 10 curing air inlets, in certain embodiments, only 9, only 8, only 7, only 6, only 5, only 4, only 3, only 2, or only 1 of the curing air inlets may introduce curing air comprising humidified air.

As explained above, in certain embodiments it may be desirable to withdraw exothermic heat from the respective curing zone(s). For example, it may be desirable to withdraw a portion of the exothermic heat generated in one or more of the curing zones and transfer said heat (i.e., heated air) to one or more curing zones upstream of the one or more of the curing zones from which the exothermic heat is transferred. In various embodiments, humidified air may be combined with this transferred heated air to form at least a portion of the curing air introduced through the curing air inlets. For example, water may be atomized, combined with the heated air transferred from the one or more curing zones from which the exothermic heat is transferred, and introduced into an upstream curing zone through one or more of the curing air inlets.

### Board Handling/Packaging

Again with reference to FIG. 1, cured boards, typically on supports and having one or more layers on either side, exit curing zone 15 and are conveyed to board handling zone 20. Boards on supports recovered from the curing zone travel along conveying means where the supports are removed from the boards. The supports are typically removed by suction and recovered and cleaned and recycled for re-use. Supports having defects or MOC not removed by cleaning are either returned for further cleaning, typically manual, or are discarded if the defects are too extensive to warrant repair.

Boards recovered from the supports are then subjected to quality control analysis including computer-controlled visual inspection of the boards. The boards are inspected for the following properties: length, width, thickness, surface roughness, and overall surface defects. Typically, quality inspection involves automated visual quality inspection utilizing high-speed cameras. The computer-controlled visual inspection is controlled by an algorithm controlled by suitable processors and controllers. In certain aspects of the present invention, the inspection algorithm incorporates lab-generated data as input(s).

Boards passing quality inspection may be cut or otherwise sized to the desired dimensions and stacked on racks. In certain embodiments, the final boards may be stacked robotically.

After the final boards have passed quality inspection and have been stacked, the boards are placed onto pallets. The pallet of stacked boards is then covered with protective sheathing, which is then secured in place using tension strips. These final steps are typically conducted manually.

Boards that do not satisfy the quality control standards may be repurposed to minimize waste. For example, rejected boards may be ground as used fillers elsewhere in the production process. To further increase process efficiencies, magnesium oxide powder material, or fines can be recovered from one or more points in the process. These include dust collection on the raw materials and the final sizing saw dust (or fines). When recovered, the fines can be introduced into the magnesium oxide storage vessel, or introduced with the other aggregates in the final wet mix.

### Board Properties

Although other forms are possible (e.g., blocks and other pre-selected forms), typically the MOC construction material is in the form of a board.

As detailed above, typically one or more aggregates, or additives are introduced into the premix and/or mixture introduced into the mixer. In various embodiments, carbon fibers are introduced as an additive. It is currently believed the presence of the carbon fibers contributes to one or more of the strength characteristics of MOC boards of the present invention. It is also currently believed that use of carbon fibers affects the MOC during curing that results in unexpected advantages. It has been observed that the volume of the MOC containing carbon fibers increases during curing. For example, it has been observed that the thickness of a final MOC board may be increased by at least about 5%, or at least about 10% as compared to its thickness prior to curing. It is currently believed this thickness/volumetric increase is provided by trapped air within the MOC associated with and attached to the carbon fibers that expands in volume because of the temperature increase during curing. In particular, it is currently believed that a dispersing agent at the carbon fiber surface (to promote dispersion of the fibers throughout the MOC mixture) attracts and traps the air that expands. This thickness/volume increase from the trapped air is not associated with any increase in weight and, thus, provides a reduction in density. Reduced density, while still exhibiting the desired strength properties is a significant advantage in terms of cost, handling, processing, etc. Thus, in accordance with the present invention MOC boards having improved strength properties are provided as compared to prior art boards, and these improvements have been observed with lighter boards that nonetheless provide the desired and required performance during and after installation. The thickness/volume increase may also be attributed to the presence of a surfactant (e.g., a siliconate) in the mixture and its reaction to the conditions of the curing reaction.

Typically, the cured board density is at least about 0.5 g/mL, at least about 0.6 g/mL, or at least about 0.7 g/mL (e.g., from about 0.5 to about 1.5 g/mL or from about 0.6 to about 1.4 g/mL).

A signal consideration of boards of the present invention is racking strength, which is a measure of board's resistance to shear loads. Typically, boards of the present invention exhibit racking strengths ranging from 400 pounds per linear foot (“plf”) to 600 plf, determined according to ASTM E72-13A (in effect as of Nov. 11, 2022). Other features, detailed below, may also be used in combination with racking strength or separately to determine whether effective boards have been prepared. In accordance with the present invention, boards exhibiting effective and advantageous racking strengths and other properties are prepared, both on an absolute and specific basis (i.e., per unit weight).

In certain embodiments, the cementitious material (i.e., boards) may be characterized by one or more of the following: (i) about 5 wt % or less, about 4 wt % or less, about 3 wt % or less, about 2 wt % or less, about 1 wt % or less, about 0.5 wt % or less, or about 0.25 wt % or less of a phosphorus-containing amorphous layer, as determined by X-Ray Diffraction (XRD); and/or (ii) a magnesium oxychloride crystal content, after a 24-hour soak in water having a temperature of 60° C., of from about 2 wt % to about 50 wt %, from about 4 wt % to about 50 wt %, from about 6 wt % to about 50 wt %, from about 8 wt % to about 50 wt %, from about 10 wt % to about 50 wt %, from about 15 wt % to about 50 wt %, from about 20 wt % to about 50 wt %, from about 25 wt % to about 50 wt %, from about 30 wt % to about 50 wt %, from about 35 wt % to about 50 wt %, or from about 40 wt % to about 50 wt %, as determined by X-Ray Diffraction; and/or (iii) a BET surface area of from about 20 m²/g to about 30 m²/g, from about 22 m²/g to about 30 m²/g, from about 24 m²/g to about 30 m²/g, from about 26 m²/g to about 30 m²/g, or from about 28 m²/g to about 30 m²/g. Typically, the cementitious material is substantially free of magnesium phosphate.

The flexural strength of the present boards is typically at least about 5 MPa, at least about 6 MPa, at least about 10 MPa, or at least about 16 MPa. The boards typically exhibit specific (i.e., on a per unit density basis) flexural strengths suitable for construction applications. The specific flexural strength is generally at least about 6 MPa/(g/cm³), at least about 10 MPa/(g/cm³), at least about 15 MPa/(g/cm³), or at least about 20 MPa/(g/cm³).

Boards prepared by the processes of the present invention typically lateral screw pull thickness of at least about 150 lbf/inch at least about 200 lbf/inch, at least about 250 lbf/inch, at least about 300 lbf/inch, at least about 350 lbf/inch, at least about 400 lbf/inch, at least about 450 lbf/inch, at least about 500 lbf/inch, at least about 550 lbf/inch, or at least about 600 lbf/inch. The boards also typically exhibit specific lateral screw pull thicknesses of at least about 150 lbf/in/(g/cm³), at least about 200 lbf/in/(g/cm³), at least about 250 lbf/in/(g/cm³), at least about 300 lbf/in/(g/cm³), at least about 350 lbf/in/(g/cm³), at least about 400 lbf/in/(g/cm³), at least about 450 lbf/in/(g/cm³), at least about 500 lbf/in/(g/cm³), at least about 550 lbf/in/(g/cm³), at least about 600 lbf/in/(g/cm³), at least about 650 lbf/in/(g/cm³), at least about 700 lbf/in/(g/cm³), at least about 750 lbf/in/(g/cm³), or at least about 800 lbf/inch/(g/cm³).

Typically, boards prepared by processes of the present invention exhibit an impact strength demonstrated by no damage as determined by a falling ball (typically having a weight of approximately 532 grams) impact test, using a twelve-inch drop as determined by ASTM D1037 (in effect as of Nov. 11, 2021).

Boards prepared by processes of the present invention typically exhibit a compression strength (Fc) of at least about 1800 PSI, or a compression strength (Fc) of from about 1800 PSI to about 2200 PSI.

Typically, boards prepared by processes of the present invention exhibit a compression indentation depth of less than about 2.5 millimeters (mm) (e.g., less than 1.3 mm or less than about 1 mm) at a pressure least about 1250 PSI, or at a pressure of from about 1500 PSI to about 3000 PSI, as determined by ASTM D2394.

The nail head pull through of boards prepared by processes of the present invention is typically at least about 90 pounds force (“lbf”), or from about 150 lbf to about 300 lbf, as determined by ASTM D1037 (in effect as of Nov. 11, 2021).

The screw pull through of boards prepared by processes of the present invention is typically at least about 175 pounds force (“lbf”), or from about 175 lbf to about 350 lbf, as determined by ASTM D1037 (in effect as of Nov. 11, 2021).

The thermal linear expansion of boards of the present invention is typically less than about 0.25%, or from about 0.01% to 0.25%, as determined by ASTM E228 (in effect as of Nov. 11, 2021).

The moisture linear expansion of boards of the present invention is typically less than about 0.25%, or from about 0.01% to 0.25%, as determined by ASTM C1185 (in effect as of Nov. 11, 2021).

Advantageously, boards of the present invention exhibit moisture stability, including being stable in water at about 60° C. for from about 24 hours to about 56 days using a Warm Water Stability Test as authenticated by Clemson University Chemical Engineering Department. Moisture stability allows the boards to be used in warm, humid, and/or cool and dry climates. Further, the moisture stability may make the boards particularly suitable for hurricane prone climates.

Boards prepared by the processes of the present invention advantageously exhibit relatively low metal corrosiveness, as evidenced by AWPAE12-94 fastener corrosion testing, measured in mills per year, with a typical range of 5 mills per year to 30 mills per year, and typically less than 35 mills per year.

Boards of the present invention are also fire resistant. For example, boards of the present invention meet the noncombustibility requirements of ASTM E136 (Standard Test Method for Assessing Combustibility of Materials Using a Vertical Tube Furnace at 750° C., as defined in the 2012, 2015 and 2018 IBC Model Codes).

Typically, boards of the present invention exhibit a vapor permeability of about 8 to about 30 Perm

In certain embodiment, a non-permeable membrane may be integrated into the board and the board does not exhibit significant vapor permeability.

Boards of the present invention may include one or more layers adhered to and/or surrounding an MOC concrete board layer. Such multi-layer boards are described, for example, in Co-Pending U.S. Provisional Patent Application Ser. No. 63/228,872, filed Aug. 3, 2021 entitled CEMENTITIOUS CONSTRUCTION MATERIAL CONTAINING MAGNESIUM OXYCHLORIDE CRYSTALS, incorporated by reference elsewhere herein. Board Analysis

In addition to visual and physical inspections, finished boards are also subjected to analysis to determine the compositional make-up of the 5-phase MOC.

Finished boards are subjected to quantitative X-ray diffraction (XRD) to identify the phases present in the final MOC cement/concrete. For example, XRD may be used to determine the proportion of 5-phase magnesium oxychloride having the molar formula Mg₃(OH)₅Cl.4H₂O present in the final MOC cementitious construction material (e.g., board). As noted elsewhere herein, it is desired for the final MOC material to contain p as high a proportion of 5-phase material as possible, typically at least about 65 wt %, at least about 70 wt %, at least about 72 wt %, at least about 74 wt %, at least about 76 wt %, at least about 78 wt %, at least about 80 wt %, at least about 82 wt %, at least about 84 wt %, at least about 86 wt %, at least about 88 wt %, at least about 90 wt %, and preferably higher.

Depending on the results of the XRD analysis, adjustments to the composition and other conditions of the premix can be made. Constituent phases of the final MOC cement/concrete include magnesium crystals and also amorphous phase cementitious material. The primary substituent of the crystalline phase is magnesium oxychloride crystals including MOC having the 5-phase make-up (i.e., the molar ratio of 5:1:13, on an active ingredient basis). Other constituents may include free chlorides (e.g., Cl⁻), magnesium oxide (MgO), and magnesium hydroxide (i.e., Mg(OH)₂).

It has been discovered that magnesium oxide purity is an important consideration or at least has been identified as a marker for producing 5-phase MOC. Purity of magnesium oxide is currently believed to be defined by two separate parameters, the presence, or availability of the magnesium oxide for reaction with magnesium chloride and whether the available magnesium chloride does in fact react effectively with the magnesium chloride. As noted, XRD measures the proportion of 5-phase material, proportion of MgO, and proportion of Mg(OH)₂ in the MOC. A relatively high proportion of MgO in the finished product indicates MgO was present and available in the starting material but did not react with magnesium chloride to form the 5-phase material. A relatively high proportion of Mg(OH)₂ indicates MgO that was present and available to be reacted, but did not react to form the 5-phase material. It is currently believed the surface area of the magnesium oxide starting material is an important factor regarding the former, while the overall purity in terms of magnesium oxide content of the starting material is an important feature regarding the latter.

Adjusting the purity and surface area of the magnesium oxide source in response to the proportions of the other phases of the MOC has therefore been identified as a manner to increase the proportion of 5-phase MOC. Typically, the magnesium oxide constitutes at least about 80 wt %, or at least about 90 wt % magnesium oxide. A correlation between the purity of MOC (i.e., available MgO and effectively reactive available MgO) and certain surface areas of MgO has been observed. Accordingly, where an increased proportion of 5-phase MOC may be desired an adjustment in the surface area of the magnesium oxide starting material may be in order. For example, as noted above, suitable magnesium oxide BET surface areas include from about 10 m²/g to about 120 m²/g, from about 10 m²/g to about 100 m²/g, from about 10 m²/g to about 80 m²/g, from about 10 m²/g to about 60 m²/g, from about 10 m²/g to 40 m²/g, from about 20 m²/g to about 40 m²/g, from about 20 m²/g to about 30 m²/g, or from about 25 m²/g to about 30 m²/g. In certain embodiments, the magnesium oxide starting material has a particle size of from about 5 m²/g to about 50 m²/g.

Although surface area, purity, particle size, etc. of the MgO source may be considered in preparing the cement premix, the overriding consideration is providing a sufficient proportion of MgO to provide the desired molar ratio for the 5-phase MOC. Therefore, so long as a sufficient proportion of MgO is provided, in various embodiments the MgO source may not exhibit one or more properties within the ranges provided herein.

If the temperature of the board during curing is too high, the board and its support will become deformed. Additionally, or alternatively, the crystalline MOC may be poorly formed resulting in poorly performing material. To avoid this, the temperature of the mixture before entering the oven is monitored. If the temperature of this mixture (i.e., the mud) needs to be adjusted, the temperature and/or density of the magnesium chloride brine may be adjusted as detailed elsewhere herein.

Further in accordance with the foregoing, purity of the starting materials and resulting mixture can be used to monitor and/or control the curing operation. A signal consideration to running a process at commercial scale is to limit the time of the curing operation. Various strategies of the processes of the present invention have been observed to allow such operation (e.g., control of the amounts of starting material, density of the magnesium chloride, amount of mixture available to convey from the mixer to the curing oven, etc.). One aspect of establishing a curing time is based on historical data gathered for the reactivity of various magnesium oxide starting materials. Data have been generated where magnesium oxide starting material purity and surface area are compared to the actual reaction time. During the reaction, the weight percentages of all components are monitored and the final, actual molar ratio for the finished MOC material is determined. From this actual molar ratio of the final material, the reactivity of the magnesium oxide starting material is determined, which can then be correlate with the properties of the magnesium oxide starting material to identify preferred starting materials based on the particular operating conditions. For example, the time and temperature conditions of the curing oven can be adjusted based on the starting material properties to provide suitable output over a commercially acceptable curing time. Accordingly, in various aspects of the present invention the composition of the magnesium oxide starting material is controlled and the time and temperature of the curing are adjusted accordingly based on historical data to achieve a commercially acceptable curing time (e.g., less than about 6 hours, or about 4 hours) and suitable output. For example, for a known surface area of magnesium oxide starting material and a selected curing time (e.g., 6 hours or 4 hours) from the curve based on the historical data a maximum curing temperature (e.g., the desired temperature to be achieved in the curing zone is elected).

### Productivity

As detailed above, MOC construction material and boards have been produced on a commercial scale, albeit with certain limitations in terms of productivity, product quality, etc. Although boards having acceptable properties have been produced on a commercial scale, often suitable production runs take significant periods such as, for example, more than 24 hours or even more than 2 days. The processes of the present invention have been observed to prepare acceptable boards at commercially significant production rates and levels. Such commercially significant production rates and levels are measured in terms of one or more of the following parameters: (i) time for production, (ii) production rates and/or output, and/or (iii) production quality. In particular, the ability of the processes of the present invention to be conducted in a continuous manner allow for considerable improvements in production rates and levels. In certain embodiments, the process from forming the magnesium oxychloride concrete mixture into a plurality of boards on a plurality of supports through curing and recovery of a final magnesium oxychloride cementitious construction material may be conducted continuously. In other embodiments, the process of preparing a cement premix and magnesium oxychloride concrete mixture may be conducted continuously or in bath operation such that the forming through curing and recovery may continue to operate in continuous mode.

Suitable times for production achieved by the processes of the present invention are less than about 24 hours, less than about 18 hours, less than about 12 hours, less than about 8 hours, less than about 6 hours, less than about 4 hours, or even less than about 2 hours or less than about 1 hour.

Further advantageously, the production processes as disclosed herein may provide increased production rates. For example, production rates of greater than about 20 linear feet/s, greater than about 25 linear feet/s, greater than about 30 linear feet/s, greater than about 35 linear feet/s, greater than about 40 linear feet/s, greater than about 45 linear feet (ft)/second (s), greater than about 50 linear ft/s, or even greater than about 60 linear ft/s may be provided.

In some embodiments, the boards are manufactured with dimensions corresponding to those of commercially available plywood, drywall and similar conventional construction materials. For example, the boards of the present invention typically have lengths ranging from about 3 feet to about 10 feet, widths from about 3 feet to about 5 feet, and thicknesses of up to 1.5 inches. Generally, output is measured in linear feet produced, but output can also be expressed in terms of volumetric output based on the length, width, and thickness of board produced during a unit time.

Moreover, the production processes of the present invention provide MOC construction material exhibiting any or all of the following properties, in particular any or all of the following properties at commercially-desired target values: flexural strength, specific flexural strength, impact strength, compression strength, compression indentation, lateral nail pull, specific lateral nail pull, nail head pull through, linear expansion, water stability, corrosiveness, fire retardant properties, and vapor permeability. In various embodiments, the processes of the present invention produce MOC construction material exhibiting commercially desirable values for these properties that do not vary outside of commercially-desired target values by more than about 10%, more than about 5%, more than about 3%, no more than about 2%, or even more than about 1% over the entirety of a production lot, or batch. Production lots, or batches may be defined in terms of the number of boards produced per hour, total linear feet of board/construction material produced per hour, and/or total square feet of board/construction material produced per hour.

### Algorithms

The systems and methods described include automated methods for production of MOC boards. Specifically, these automated methods include algorithms and computer-implemented methods for managing various aspects of MOC board production including those described herein and, for example and without limitation, (a) integration, collection, and/or assembly of starting materials (or precursors), (b) premixing, (c) mixing, (d) curing, (e) MOC board handling, cutting, and creation, and (f) packaging.

In some examples, these steps are performed using a computing device that may include computing hardware, software, and infrastructure necessary for hosting and/or executing a variety of applications. As such, the computing device may include physical computing resources, such as processors, storage devices, networking infrastructure, and the like. Further, in some embodiments the computing devices may include software and/or firmware for establishing and managing hardware virtualization (e.g., the creation and management of virtual machines) hosted on the computing devices. In some embodiments, the computing devices may be housed within data centers. In some embodiments, the computing devices may be included within or operated by or in conjunction with the machines described herein, or may be provided by another entity. In some examples, the computing devices may be in networked communication with the equipment for integration, collection, and/or assembly, premixing, mixing, curing, MOC board handling, and packaging. In some such examples, the computing devices may be located in a variety of different geographic locations. In other examples, the steps are performed using a pre-programmed processor, printed circuit board (“PCB”), or equivalent logical circuits and used to control the equipment described above for integration, collection, and/or assembly, premixing, mixing, curing, MOC board handling, and packaging, directly or indirectly.

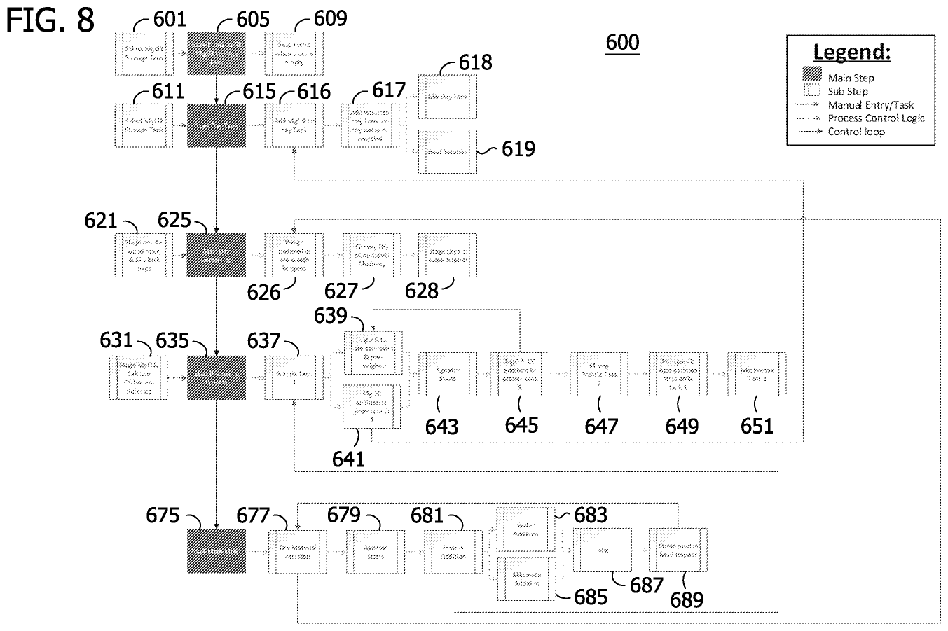

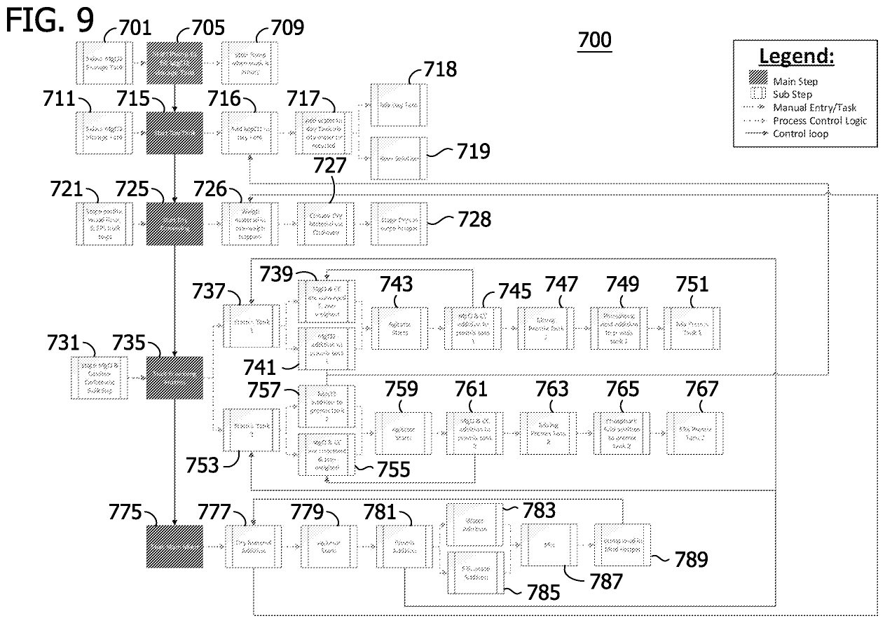

In an example embodiment, the steps include a process that is shown in FIGS. 7 and 8 and moves from steps (a)-(c) (i.e., integration, collection, and/or assembly, premixing, and mixing). More specifically, FIG. 7 depicts the process 600 of (a)-(c) beginning with the step of starting a pump 605 to fill the MgCl₂ storage tank. In the example embodiment, starting a pump 605 begins with selection 601 of a suitable MgC12 storage tank from one or more storage tank options (using a suitable interface or a pre-configured setting) and ends with stopping 609 the pump. Stopping 609 the pump may be determined when the source (e.g., a truck or another tank) used to supply the MgCl₂ is empty or when the MgCl₂ storage tank is determined to be filled. In an example embodiment, the method utilizes sensors that can variously identify and track sources for MgCl₂, begin the pumping process from the source to the MgCl₂ storage tank, and sense the relative volume, weight, pressure, or other status of the source or MgCl₂ storage tanks.

Process 600 also includes starting 615 the day tank. In the example embodiment, starting the day tank 615 begins with selection 611 of a suitable MgCl₂ storage tank from one or more storage tank options (using a suitable interface or a pre-configured setting) and continues with the step of adding MgCl₂ 616 to the day tank, adding water 617 to the day tank (using any water including public/city/municipal water, stored tank water, recycled water, or any other suitable source), and instructing the mixing 618 of the day tank and heating 619 of the solution per the specifications described herein. Typically, the temperature of the magnesium chloride brine is at least about 5° C. (about 40° F.), at least about 10° C. (about 50° F.), at least about 20° C. (about 65° F.), or at least about 30° C. (about 85° F.). Generally, the temperature of the magnesium chloride brine is from about 5° C. (about 40° F.) to about 45° C. (about 110° F.), or from about 10° C. (about 50° F.) to about 40° C. (about 105° F.). The water and source of magnesium chloride brine are typically mixed using a suitable agitator. As detailed elsewhere herein, the density and temperature of the magnesium chloride brine are controlled and maintained to provide a brine of the desired composition (i.e., molar ratio of magnesium chloride and water). The temperature of the brine is monitored by a temperature sensor connected to the brine storage vessel and, if needed, heat may be introduced into the brine storage vessel.

Process 600 further includes starting 625 dry conveying. In the example embodiment, starting 625 dry conveying includes staging materials 621. Staging materials 621 may include staging perlite, wood flour, and expanded polystyrene (“EPS”) bulk bags, along with any other dry ingredients. Starting 625 dry conveying also includes weighing 626 material in pre-weigh hoppers, conveying 627 dry materials using chain conveyers (or “chainveys”), and staging 628 dry materials in a surge hopper.

Process 600 also includes starting 635 a premixing process. In the example embodiment, starting 635 the premixing process includes begins with staging 631 magnesium oxide (MgO) and calcium carbonate from sources (e.g., bulk bags) and continuing into the premixing process including causing the magnesium oxide and calcium carbonate to enter a first premix tank 637 (e.g., Premix Tank 1). In some embodiments, calcium carbonate may be omitted. Process 600 further causes the magnesium oxide and calcium carbonate to be conveyed and pre-weighed 639 and, in parallel, causes the magnesium chloride (MgCl₂)to be added 641 to the first premix tank. (In some examples, adding 641 magnesium chloride drives or causes adding 616 MgCl₂ to the day tank. Process 600 also causes a first agitator to start 643 to mix the elements in the first premix tank and add, as necessary, additional elements including magnesium oxide and calcium carbonate 645 to the first premix tank. (In some examples, where additional elements are added 645, process 600 repeats steps 639 and/or step 641 to convey and pre-weigh the added elements and further add magnesium chloride to the first premix tank.) Process 600 also causes the mixing 647 of the first premix tank and further addition 649 of phosphoric acid to the first premix tank along with a further mixing 651 of the first premix tank.

Processor 600 further includes a starting 675 main mixer process. Starting 675 main mixer process further includes a dry material addition 677, causing the first agitator to start 679, and a premix addition 681. In some examples, dry material addition 677 drives weighing 626. In some examples, premix addition 681 is used to drive step 637 and provide premix to the first premix tank. Starting 675 also includes adding 683 water and adding 685 siliconate. Starting 675 further includes mixing 687 the main mixer and dumping 689 mud in the mud hopper. In some examples, dumping 689 requires returning to dry material addition 677. In further examples, dry material addition 677 includes returning to weighing 626 step.

FIG. 8 reflects a first variation process 700 to process 600 wherein the premixing process 735 uses a first and second premix tank (in contrast to premixing process 635 which utilizes a first premix tank). As indicated, in other examples, variations may be introduced with varying amounts of tanks, day tanks, premix tanks, main tanks, and other relevant instruments.

FIG. 8 depicts the process 700 of (a)-(c) beginning with the step of starting a pump 705 to fill the MgCl₂ storage tank. In the example embodiment, starting a pump 705 begins with selection 701 of a suitable MgCl₂ storage tank from one or more storage tank options (using a suitable interface or a pre-configured setting) and ends with stopping 709 the pump. Stopping 709 the pump may be determined when the source (e.g., a truck or another tank) used to supply the MgCl₂ is empty or when the MgCl₂ storage tank is determined to be filled. In an example embodiment, the method utilizes sensors that can variously identify and track sources for MgCl₂, begin the pumping process from the source to the MgCl₂ storage tank, and sense the relative volume, weight, pressure, or other status of the source or MgCl₂ storage tanks.

Process 700 also includes starting 715 the day tank. In the example embodiment, starting the day tank 715 begins with selection 711 of a suitable MgCl₂ storage tank from one or more storage tank options (using a suitable interface or a pre-configured setting) and continues with the step of adding MgCl₂ 716 to the day tank, adding water 717 to the day tank (using any water including public/city/municipal water, stored tank water, recycled water, or any other suitable source), and instructing the mixing 718 of the day tank and heating 719 of the solution per the specifications described herein. Typically, the temperature of the magnesium chloride brine is at least about 5° C. (about 40° F.), at least about 10° C. (about 50° F.), at least about 20° C. (about 65° F.), or at least about 30° C. (about 85° F.). Generally, the temperature of the magnesium chloride brine is from about 5° C. (about 40° F.) to about 60° C. (140° F.), from about 5° C. (40° F.) to about 45° C. (115° F.), or from about 10° C. (about 50° F.) to about 40° C. (about 105° F.). The water and source of magnesium chloride brine are typically mixed using a suitable agitator. As detailed elsewhere herein, the density and temperature of the magnesium chloride brine are controlled and maintained to provide a brine of the desired composition (i.e., stoichiometric ratio of magnesium chloride and water). The temperature of the brine is monitored by a temperature sensor connected to the brine storage vessel and, if needed, heat may be introduced into the brine storage vessel.

Process 700 further includes starting 725 dry conveying. In the example embodiment, starting 725 dry conveying includes staging materials 721. Staging materials 721 may include staging perlite, wood flour, and expanded polystyrene (“EPS”) bulk bags, along with any other dry ingredients. Starting 725 dry conveying also includes weighing 726 material in pre-weigh hoppers, conveying 727 dry materials using chain conveyers (or “chainveys”), and staging 728 dry materials in a surge hopper. Process 700 also includes starting 735 a premixing process. In the example embodiment, starting 735 the premixing process includes begins with staging 731 magnesium oxide (MgO) and calcium carbonate from sources (e.g., bulk bags) and continuing into the premixing process including causing the magnesium oxide and calcium carbonate to enter a first premix tank 737 (e.g., Premix Tank 1). In some embodiments, calcium carbonate may not be used. Process 700 further causes the magnesium oxide and calcium carbonate to be conveyed and pre-weighed 739 and, in parallel, causes the magnesium chloride (MgCl₂)to be added 741 to the first premix tank. (In some examples, adding 741 magnesium chloride drives or causes adding 716 MgCl₂ to the day tank. Process 700 also causes a first agitator to start 743 to mix the elements in the first premix tank and add, as necessary, additional elements including magnesium oxide and calcium carbonate 745 to the first premix tank. (In some examples, where additional elements are added 745, process 700 repeats step 739 and/or step 741 to convey and pre-weigh the added elements and further add magnesium chloride to the first premix tank.) Process 700 also causes the mixing 747 of the first premix tank and further addition 749 of phosphoric acid to the first premix tank along with a further mixing 751 of the first premix tank. Starting 735 also includes utilizing a second premix tank (e.g., Premix Tank 2). Thus, starting 735 also includes continuing into the premixing process including causing the magnesium oxide and calcium carbonate to enter a second premix tank 753 (e.g., Premix Tank 2). Process 700 further causes the magnesium oxide and calcium carbonate to be conveyed and pre-weighed 755 and, in parallel, causes the magnesium chloride (MgCl₂)to be added 757 to the second premix tank. In some examples, adding 757 magnesium chloride drives or causes adding 716 MgCl₂ to the day tank. Process 700 also causes a second agitator to start 759 to mix the elements in the second premix tank and add, as necessary, additional elements including magnesium oxide and calcium carbonate 761 to the second premix tank. (In some examples, where additional elements are added 761, process 700 repeats step 755 and/or step 757 to convey and pre-weigh the added elements and further add magnesium chloride to the second premix tank.) Process 700 also causes the mixing 763 of the second premix tank and further addition 765 of phosphoric acid to the second premix tank along with a further mixing 767 of the second premix tank.

Process 700 further includes a starting 775 main mixer process. Starting 775 main mixer process further includes a dry material addition 777, causing the first agitator to start 779, and a premix addition 781. In some examples, dry material addition 777 drives weighing 726. In some examples, premix addition 781 is used to drive step 737 and provide premix to the first premix tank. Starting 775 also includes adding 783 water and adding 785 siliconate. Starting 775 further includes mixing 787 the main mixer and dumping 789 mud in the mud hopper. In some examples, dumping 789 requires returning to dry material addition 777. In further examples, dry material addition 777 includes returning to weighing 726 step.

As described above and herein, processes 600 and 700 are effected using automation that may include using a computing device that may include computing hardware, software, and infrastructure necessary for hosting and/or executing a variety of applications. Alternately, processes 600 and 700 may be performed using PCBs or other components suitable to control the operation of one or more machines. In example embodiments, all or substantially all of the steps of processes 600 and 700 (and variations thereto) are performed automatically wherein the operation of the mechanical components (e.g., pumps, tanks, mixers, conveyers, weighing instruments, heaters, coolers, water injection, chemical injection, agitation, and loading) are performed by an automated tool controlling these mechanical components.

In a similar manner, as described herein, such computing devices and similar elements may be used to control the methods and algorithms for creating and preparing MOC boards including, for example, management and control of the dynamic oven.

Thus, in at least some examples, the computing devices, processors, PCBs, or other components that implement the methods described are in communication with components to execute the functions described including, for example, pumps, tanks, mixing elements, conveying elements, weighing elements, heating elements, cooling elements, water injection elements, chemical injection elements, agitators, and loading elements.

Further in accordance with the present invention, there may be automated methods including algorithms and computer-implemented methods for integration, collection, and/or assembly of starting materials. These steps may be conducted as set forth above in connection with the description of the processes described in FIGS. 7 and 8 (i.e., utilizing a computing device that may include computing hardware, software, and infrastructure necessary for hosting and/or executing a variety of applications). In an example embodiment, the steps may involve identifying one or more process conditions and, based on these conditions, selecting the appropriate starting material(s). For example, depending on these conditions, a particular magnesium oxide starting material may be selected or a magnesium chloride brine of a particular strength may be selected. These process conditions include, for example, magnesium chloride brine temperature and/or density, mixing time, curing temperature, etc. In another embodiment, the steps may involve identifying one or more desired properties of the finished board and selecting the appropriate starting material(s). The desired board properties may include, for example, MOC content of the finished board, flexural strength, etc.

The processes of the present invention satisfy a need in the art by providing MOC boards with consistent and/or enhanced individual performance characteristics of the boards and improved systems and processes for the commercial manufacture of MOC boards with such consistent and enhanced individual performance characteristics.

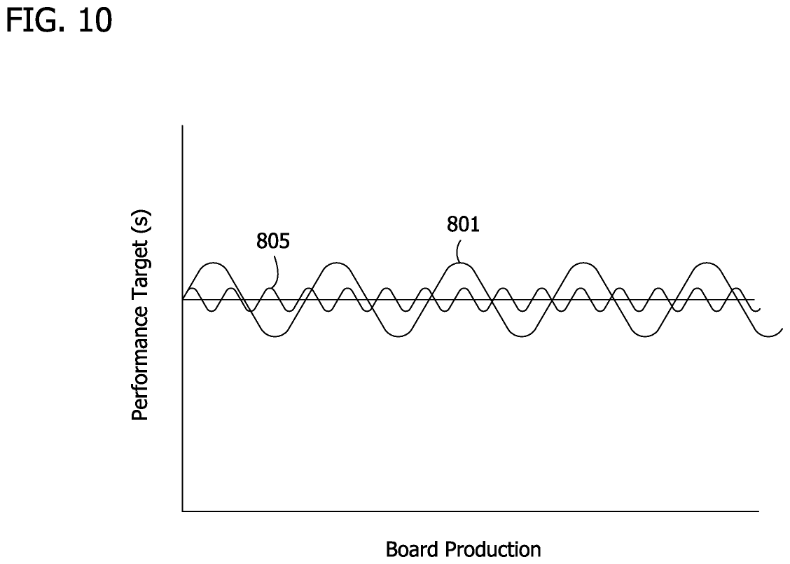

FIG. 10 provides representative plots indicating the variation in performance target(s) during board production for prior art processes (plot 801) and the variations provided by the present processes (plot 805). These performance target(s) may include flexural strength or MOC efficacy. MOC efficacy may be defined as a ratio of actual 5-phase MOC content divided by the intended (or targeted) 5-phase MOC content. Since required flexural strength can vary depending on the application, these plots do not indicate precise, or absolute values for the flexural strength, but rather indicate variation in flexural strength observed for the present processes and processes of the prior art. Board production may be characterized in terms of total processing time and/or total board output. Overall, suitable performance target(s) include flexural strength and MOC efficacy (y-axis on FIG. 10) that may be characterized in terms of processing time and/or board output (x-axis on FIG. 10).

The present processes have been observed to provide variations in flexural strength of less than about 10%, less than about 5%, less than about 3%, or even less than about 1% over the course of production lots. Production lots where such variations in flexural strength have been observed may be defined by processing times of 1 hour, 2 hours 3 hours, or even four hours. Production lots where such limited variations in flexural strength have been observed may also be defined in terms of total linear feet of board produced per unit time. For example, production lots may produce at least about 20 linear feet/s, at least about 25 linear feet/s, at least about 30 linear feet/s, at least about 35 linear feet/s, at least about 40 linear feet/s, at least about 45 linear feet/s, at least about 50 linear feet/s, or at least about 60 linear feet/s of board. Boards produced at these rates and within these variations in the target property may exhibit flexural strength in excess of 5 MPa.

Flexural strength can be measured using suitable methods known in the art. Alternatively, the boards may be measured by on-line XRD to determine the composition of the MOC (e.g., percentage of MOC content in the final board). MOC content has been observed to correlate with flexural strength and, therefore, this compositional measurement can be an indicator of producing boards having the desired properties.

The processes of the present invention have also been observed to provide advantageous process efficiencies in terms of providing boards having a desired, or target MOC content. In particular, as measured by on-line XRD for finished boards, typically a target value of MOC content for the final cementitious boards is set as the performance target. The target MOC content can vary depending on the particular application, but often is somewhere between about 70 wt % and about 80 wt % (e.g., about 75 wt %) of the finished board. In accordance with the processes of the present invention, target MOC contents are typically provided at an overall process efficiency of greater than 90%, and often at a process efficiency of from about 95% to about 99%. A process efficiency of 95% indicates all boards produced vary from the target MOC value by no more than 5%. For example, for a target MOC content of 80 wt %, a 95% process efficiency would include all boards had an MOC content of from 80% +/−5% (i.e., from 76% to 84%).

Again with reference to FIG. 10, variations in the performance target can be attributed to various factors, including (i) inherent variations in raw material, handing, etc.; (ii) human (operator) error; (iii) inherent various in the process; and (iv) inherent variations in laboratory formulations. Typically, some amount of the variation in the performance target is attributable to a combination of each of these factors. For example, prior art processes have been observed to provide process efficiencies often around 60%, or possibly a bit higher at around 70%. Typically, any or all of the listed factors have been observed to contribute 5%, or more (e.g., 10%) of the variation in performance from the performance target. In addition to improved overall process efficiencies as detailed above (e.g., 90% or above), the processes of the present invention have been observed to provide improved efficiencies in terms of each of the individual factors listed above. For example, typically the variation in process efficiency attributed to each of these factors is less than 5% each and, more typically, by less than 4% or even 2% for any or all of these factors. In various embodiments, it has been observed that the variation in process efficiency attributed to inherent variations in the process and inherent variations in laboratory formulations are significantly lower than those expected in prior art process (e.g., less than 5%, or even less than 2%).

### Embodiments

Embodiment 1 is a process for making a cementitious construction material, the process comprising:

providing a magnesium chloride brine comprising a mixture of magnesium chloride in water;

combining the magnesium chloride brine with a source of magnesium oxide in a premixer, thereby forming a premix comprising magnesium oxide and magnesium chloride;

conveying the premix to a mixer;

mixing the premix in the mixer for a mixing period, thereby forming a magnesium oxychloride mixture;

conveying the magnesium oxychloride mixture through a curing oven having an inlet and an outlet and comprising a plurality of heating zones, wherein during said conveying the magnesium oxychloride mixture is cured to form cementitious construction material comprising magnesium oxychloride crystals, wherein:

the density of the magnesium chloride brine is maintained at a target value of from about 1.15 g/mL to about 1.30 g/mL; and/or

the source of magnesium oxide has a particle size of from about 5 m²/g to about 50 m²/g; and/or

cementitious construction comprising magnesium oxychloride crystals passes through the outlet of the curing oven at a rate of at least about 40 linear feet/hour; and/or

the relative humidity within each of the plurality of heating zones is continuously monitored and optionally adjusted if necessary to maintain the humidity within a desired range.

Embodiment 2 is the process as set forth in Embodiment 1, the process further comprising:

introducing the magnesium oxychloride mixture into a holding vessel (mud hopper);

removing magnesium oxychloride mixture from the holding vessel and conveying magnesium oxychloride mixture onto one or supports; and

conveying the one or supports having the magnesium oxychloride mixture into the curing oven, wherein the plurality of heating zones comprises a first heating zone having a temperature within the first heating zone no more than about 50° C. (about 120° F.) greater than the temperature of the magnesium oxychloride mixture introduced into the holding vessel.

Embodiment 3 is the process of Embodiment 2, wherein the temperature within the first heating zone is no more than about 20° C. (about 68° F.) greater than the temperature of the magnesium oxychloride mixture introduced into the holding vessel.

Embodiment 4 is the process of Embodiment 2 wherein the temperature within the first heating zone is less than about 80° C. (about 180° F.), or from about 80° C. (about 180° F.) to about 65° C. (about 150° F.).

Embodiment 5 is the process of any of Embodiments 2 to 4 wherein conveying the magnesium oxychloride mixture onto the one or more supports comprising passing the mixture through an extruder.

Embodiment 6 is the process as set forth in Embodiment 1, the process further comprising:

monitoring the temperature of the magnesium oxychloride mixture in the mixer;

comparing the temperature of the magnesium oxychloride mixture in the mixer to a desired temperature; and

optionally adjusting the temperature of the premix.

Embodiment 7 is the process of Embodiment 6 wherein the temperature of the premix is adjusted by addition of heat to the magnesium chloride brine.

Embodiment 8 is the process of Embodiment 6 wherein the temperature of the premix is adjusted by addition of water and/or magnesium chloride to the magnesium chloride brine.

Embodiment 9 is the process of any of the preceding Embodiments wherein the temperature of the magnesium chloride brine is at least about 5° C. (about 40° F.), at least about 10° C. (about 50° F.), at least about 20° C. (about 65° F.), at least about 30° C. (about 85° F.), from about 5° C. (about 40° F.) to about 60° C. (140° F.), from about 5° C. (40° F.) to about 45° C. (115° F.), or from about 10° C. (about 50° F.) to about 40° C. (about 105° F.).

Embodiment 10 is the process of any of the preceding Embodiments wherein the density of the magnesium chloride brine is at least about 1.20 g/mL, at least about 1.25 g/mL, or at least about 1.28 g/mL.

Embodiment 11 is the process of Embodiment 10 wherein the density of the magnesium chloride brine is maintained within a desired range by addition of heat, magnesium chloride, and/or water thereto.

Embodiment 12is the process of any of the preceding Embodiments, wherein the density of the magnesium chloride brine is adjusted in response to a deviation in the temperature of the magnesium oxychloride mixture from the desired temperature.

Embodiment 13 is the process of Embodiment 12, wherein the density of the magnesium chloride solution is adjusted by adding magnesium chloride and/or water to the magnesium chloride solution.

Embodiment 14 is the process of any of any of the preceding Embodiments, wherein the magnesium chloride brine is stored in a corrosion-resistant and saltwater-resistant vessel.

Embodiment 15 is the process of any of the preceding Embodiments, wherein the magnesium chloride brine contains magnesium chloride and water at a stoichiometric ratio of approximately 1:13, or 1:13.

Embodiment 16 is the process of any of the preceding Embodiments, wherein the premix contains magnesium oxide (MgO), magnesium chloride (MgCl₂)and water (H₂O) at a stoichiometric ratio of at least about 5.1:1:13, at least about 5.2:1:13, or at least about 5.3:1:13, respectively.

Embodiment 17 is the process of any the preceding Embodiments, wherein providing the magnesium chloride brine comprises removing magnesium chloride brine from a storage vessel and combining the source of magnesium oxide with the magnesium chloride brine comprises removing the source of magnesium oxide from a storage vessel, the process further comprising:

determining the amount of magnesium oxide removed from the storage vessel by a loss-in-weight scale;

determining the amount of magnesium chloride brine removed from the storage vessel by a loss-in-weight scale; and

comparing the sum of these amounts to the weight of premix in the premix vessel, wherein the comparing is conducted continuously using a weigh cell that measures the weight of premix in the premix vessel.

Embodiment 18 is the process of Embodiment 17 wherein the weight of the premix in the premix vessel is compared to a set-point, the process further comprising optionally adjusting the weight the magnesium oxide removed from the storage vessel and/or the weight of the magnesium chloride brine removed from the storage vessel in response to a deviation in the weight of the premix from the set-point.

Embodiment 19 is the process of the any of the preceding Embodiments, the process further comprising:

removing one or more aggregates from one or more aggregate storage vessels; and

introducing the one or more aggregates into the mixer.

Embodiment 20 is the process of Embodiment 19, the process further comprising determining the amount of one or more aggregates removed from the one or more aggregate storage vessels using loss-in-weight scales associated with each of the aggregate storage vessels;

determining the weight of the mixture containing the one or more aggregates;

comparing the weight of the mixture to a set-point; and

optionally adjusting the weight of the mixture by addition of magnesium oxide starting material, magnesium chloride starting material, and/or one or more aggregates thereto.

Embodiment 21 is the process of Embodiment 19 or 20 wherein the one or more aggregates are selected from carbon fibers, wood, perlite, foam beads, glass, and calcium carbonate powder.

Embodiment 22 is the process of any of the preceding Embodiments, the process further comprising introducing phosphorous acid (H₃PO₃) and/or phosphoric acid (H₃PO₄) into the premix prior to its introduction into the mixer.

Embodiment 23 is a process for making a cementitious construction material, the process comprising:

providing a magnesium chloride brine comprising a mixture of magnesium chloride in water;

combining the magnesium chloride brine with a source of magnesium oxide in a premixer, thereby forming a premix comprising magnesium oxide and magnesium chloride;

conveying the premix to a mixer;

mixing the premix in the mixer for a mixing period, thereby forming a magnesium oxychloride mixture;

conveying the magnesium oxychloride mixture through a curing oven having an inlet and an outlet and comprising a plurality of heating zones, wherein during said conveying the magnesium oxychloride mixture is cured to form cementitious construction material comprising magnesium oxychloride crystals;

identifying the purity and/or surface area of the magnesium oxide starting material; and

selecting one or more curing conditions of the curing oven based on the purity and/or surface area of the magnesium oxide starting material, wherein the one or more curing conditions are selected from the time for conveying the magnesium oxychloride mixture through the curing oven, the temperature within one or more of the heating zones, or a combination thereof.

Embodiment 24 is a process for making a cementitious construction material, the process comprising:

providing a magnesium chloride brine comprising a mixture of magnesium chloride in water;

combining the magnesium chloride brine with a source of magnesium oxide in a premixer, thereby forming a premix comprising magnesium oxide and magnesium chloride;

conveying the premix to a mixer;

mixing the premix in the mixer for a mixing period, thereby forming a magnesium oxychloride mixture;

conveying the magnesium oxychloride mixture through a curing oven having an inlet and outlet and comprising having a plurality of heating zones, wherein during said conveying the magnesium oxychloride mixture is cured to form cementitious construction material comprising magnesium oxychloride crystals (MOC);

identifying components of the cementitious construction material, wherein the components include 5-phase MOC, magnesium oxide (MgO), and magnesium hydroxide (Mg(OH)₂); and

adjusting one or more curing conditions of the curing oven based on the proportion of 5-phase MOC in the cementitious construction material, wherein the one or more curing conditions are selected from the time for conveying the magnesium oxychloride mixture through the curing oven, the temperature within one or more of the heating zones, or a combination thereof.

Embodiment 25 is a process for making a cementitious construction material, the process comprising:

providing a magnesium chloride brine comprising a mixture of magnesium chloride in water;

combining the magnesium chloride brine with a source of magnesium oxide in a premixer, thereby forming a premix comprising magnesium oxide and magnesium chloride;

conveying the premix to a mixer;

mixing the premix in the mixer for a mixing period, thereby forming a magnesium oxychloride mixture;

conveying the magnesium oxychloride mixture through a curing oven having an inlet and an outlet and comprising a plurality of heating zones, wherein during said conveying the magnesium oxychloride mixture is cured to form cementitious construction material comprising magnesium oxychloride crystals (MOC);

identifying one or more properties of the source of magnesium oxide, wherein the one or more properties are selected from the group consisting of magnesium oxide content, BET surface area, or a combination thereof; and

establishing one or more curing conditions of the curing oven based on the one or more properties of the source of magnesium oxide, wherein the one or more curing conditions are selected from the time for conveying the magnesium oxychloride mixture through the curing oven, the temperature within one or more of the heating zones, or a combination thereof.

Embodiment 26 is a process for making a cementitious construction material, the process comprising:

removing particulate magnesium oxide from a storage vessel and introducing into a premix vessel;

removing magnesium chloride brine from a storage vessel and introducing into the premix vessel;

combining the magnesium oxide and the magnesium chloride brine in the premix vessel, thereby forming a premix comprising magnesium oxide and magnesium chloride;

monitoring the density of the magnesium chloride brine;

comparing the density of the magnesium chloride brine to a desired set-point; and

optionally adjusting the density of the magnesium chloride brine in response to a deviation from said set-point, wherein adjusting comprises addition of magnesium chloride and/or water to the magnesium chloride brine.

Embodiment 27 is a continuous process for making a cementitious construction material, the process comprising:

continuously blending particulate magnesium oxide starting material and magnesium chloride starting material in the form of a magnesium chloride solution, thereby forming a premix comprising magnesium oxide and magnesium chloride;

continuously introducing the premix into a mixer comprising one or more paddles for mixing of the premix;

continuously mixing the premix in the mixer for a mixing period, thereby forming a magnesium oxychloride mixture;

continuously removing the magnesium oxychloride mixture from the mixer;

continuously conveying the mixture into an oven having a plurality of heating zones, the plurality of heating zones comprising a first heating zone, a second heating zone, and a third heating zone; and

continuously heating the mixture within the oven, thereby forming a cementitious construction material comprising magnesium oxychloride crystals.

Embodiment 28 is a continuous process for making a cementitious construction material, the process comprising:

removing magnesium oxide starting material from a storage vessel and introducing into a premix vessel;

removing magnesium chloride brine from a storage vessel and introducing into the premix vessel;

combining the magnesium oxide starting material and the magnesium chloride brine in the premix vessel, thereby forming a premix comprising magnesium oxide and magnesium chloride;

introducing the premix into a mixer for mixing of the premix;

mixing the premix in the mixer for a mixing period, thereby forming a magnesium oxychloride mixture;

removing the magnesium oxychloride mixture from the mixer and introducing into a holding vessel (mud hopper);

transferring one or more portions of the magnesium oxychloride mixture from the holding vessel onto one or more supports;

conveying the one or more supports having the magnesium oxychloride mixture thereon through an oven having a plurality of heating zones, thereby curing the magnesium oxychloride mixture and forming cementitious construction material comprising magnesium oxychloride crystals on the one or more supports; and

recovering one or more boards from the one or more supports, wherein:

the magnesium oxychloride mixture is continuously removed from the holding vessel while boards are recovered from the one or more supports.

Embodiment 29 is the process of Embodiment 28, wherein the capacity of the holding vessel is greater than the capacity of the mixer and the proportion of the oxychloride mixture maintained with the holding vessel exceeds the capacity of the mixer while boards are recovered from the one or more supports.

Embodiment 30 is a continuous process for making a cementitious construction material, the process comprising:

removing magnesium oxide from a storage vessel and introducing into the premix vessel;

determining the amount of magnesium oxide removed from the storage vessel by a loss-in-weight scale;

removing magnesium chloride brine from a storage vessel and introducing into the premix vessel;

determining the amount of magnesium chloride brine removed from the storage vessel by loss-in-weight scales;

combining the magnesium oxide and the magnesium chloride brine in the premix vessel, thereby forming a premix comprising magnesium oxide and magnesium chloride;

continuously comparing the sum of the amounts of magnesium oxide and magnesium chloride to the weight of premix in the premix vessel, and optionally adjusting the weight of premix by addition of magnesium oxide and/or magnesium chloride brine thereto;

introducing one or more aggregates into the premix;

determining the amount of the one or more aggregates introduced into the premix by one or more loss-in-weight scales;

introducing the premix containing the one or more aggregates into a mixer comprising one or more paddles for mixing of the premix; and

mixing the premix in the mixer for a mixing period, thereby forming a magnesium oxychloride mixture, wherein the process further comprises continuously monitoring the amount of magnesium oxychloride mixture in the mixer, and optionally adjusting the weight of the mixture in response to a deviation from a set-point by addition of magnesium oxide, magnesium chloride, and/or one or more aggregates thereto.

Embodiment 31 is a process for making cementitious construction material, the process comprising:

introducing one or more supports having a magnesium oxychloride mixture thereon into a curing oven; and

curing the magnesium oxychloride mixture, thereby forming cementitious construction material comprising magnesium oxychloride crystals; wherein:

the oven comprises an inlet, an outlet, means for conveying the supports along a path from the inlet to the outlet, a plurality of zones arranged longitudinally along the path from the inlet to the outlet, and one or more conduits in fluid communication with the oven for circulation of heat within the oven and/or introduction of heat thereto; wherein:

the plurality of zones comprises a first zone, a second zone, and a third heating zone; and

curing of the magnesium oxychloride mixture occurs as the supports travel along the path from the oven inlet to the oven outlet, the supports being in constant motion during travel along the path.

Embodiment 32 is the process of Embodiment 31 wherein the temperature within the second zone is higher than the temperature within the first zone, and the temperature within the third zone is higher than the temperature within the second zone.

Embodiment 33 is the process of Embodiment 31 or 32 wherein the oven comprises a housing, the housing having one or more vents and/or conduits for removal of heat from the oven and/or addition of heat thereto.

Embodiment 34 is the process of any of Embodiments 31 to 33 wherein the oven further comprises temperature sensors and temperature controls for each of the zones.

Embodiment 35 is the process of any of Embodiments 31 to 34 wherein:

the temperature of the magnesium oxychloride mixture is heated to a curing temperature in the first zone;

the temperature of the magnesium oxychloride mixture is maintained at the curing temperature for a curing time in the second zone, thereby forming cementitious construction material comprising magnesium oxychloride crystals; and

the cementitious construction material is cooled in the third zone prior to its reaching the outlet of the oven.

Embodiment 36 is the process of Embodiment 35, wherein the reaction between magnesium oxide and magnesium chloride at the curing temperature is exothermic, thereby generating heat within the second zone

Embodiment 37 is the process of Embodiment 36, the process further requiring recovering heat generated within the second zone, and introducing the recovered heat into the first zone.

Embodiment 38 is the process of any of Embodiments 31 to 37 wherein each zone comprises one or more sensors for monitoring the temperature and comparing to a set temperature, the temperature of each zone optionally being adjusted to within its desired range by introduction of heat thereto, or removal of heat therefrom.

Embodiment 39 is a process for making cementitious construction material, the process comprising:

introducing one or more supports having a magnesium oxychloride mixture thereon into a curing oven; and

curing the magnesium oxychloride mixture, thereby forming cementitious construction material comprising magnesium oxychloride crystals; wherein:

the oven comprises an inlet, an outlet, means for conveying the supports along a path from the inlet to the outlet, and a plurality of zones arranged along the path from the inlet to the outlet; wherein:

the plurality of zones comprises a first zone, a second zone, and a third zone along the path from the inlet to the outlet; and

curing of the magnesium oxychloride mixture occurs as the supports travel through the plurality of zones along the path from the oven inlet to the oven outlet, wherein the relative humidity within each of the plurality of zones is greater than 50%.

Embodiment 40 is the process of Embodiment 39, the process further requiring continuously monitoring the relative humidity of each of the plurality of zone and optionally adjusting the humidity of one or more zones in response to a deviation from a set-point.

Embodiment 41 is the process as set forth in any of Embodiments 1 to 40, wherein the cementitious construction material comprises a production lot of a plurality of boards, each of the plurality of boards having a flexural strength and wherein the variation in flexural strength for the production lot from a target value is less than about 10%, less than about 5%, less than about 3%, or less than about 1%.

Embodiment 42 is the process as set forth in Embodiment 41, wherein the target value of flexural strength for the production lot is at least about 5 MPa.

Embodiment 43 is the process as set forth in Embodiment 41 or 42, wherein the cementitious construction material comprises a production lot of a plurality boards, each of the plurality of boards having an MOC content within about 5% of a target value of MOC content.

Embodiment 44 is the process as set forth in Embodiment 43, wherein the target value of MOC content for each of the plurality of boards is from about 70 wt % to about 80 wt %.

Embodiment 45 is the process as set forth in any of Embodiments 41 to 44 wherein the production lot of the plurality of boards is produced at a rate of at least about 45 linear feet/s of board.

Embodiment 46 is the process as set forth in any of Embodiments 41 to 45 wherein the production lot is produced over a period of from about 1 hour to about 4 hours.

Embodiment 47 is a process for making a cementitious construction material, the process comprising:

(i) blending particulate magnesium oxide and magnesium chloride brine, thereby forming a premix comprising magnesium oxide and magnesium chloride;

(ii) introducing the premix into a mixer;

(iii) mixing the premix in the mixer for a mixing period, thereby forming a magnesium oxychloride mixture;

(iv) removing the magnesium oxychloride mixture from the mixer and introducing into a holding vessel;

(v) transferring one or more portions of the magnesium oxychloride mixture from the holding vessel onto one or more supports; and

(vi) conveying the one or more supports having the magnesium oxychloride mixture thereon through an oven, wherein the magnesium oxychloride mixture is cured within the oven to form a cementitious construction material comprising magnesium oxychloride crystals, and

(vii) recovering the one or more supports from the oven and removing the cementitious construction material from the one or more supports, and

(viii) forming a production lot of boards from the construction material removed from the one or more supports, wherein:

the production lot of boards comprises a plurality of boards, each of the plurality of boards having a flexural strength within about 10% of a target value of flexural strength.

Embodiment 48 is the process as set forth in Embodiment 47 wherein each of the plurality of boards has a flexural strength within about 5%, within about 3%, or within about 1% of the target value of flexural strength.

Embodiment 49 is the process of Embodiment 47 or 48 wherein the target value of flexural strength for each of the plurality of boards is at least about 5 MPa.

Embodiment 50 is a process for making a cementitious construction material, the process comprising:

(i) blending particulate magnesium oxide and magnesium chloride brine, thereby forming a premix comprising magnesium oxide and magnesium chloride;

(ii) introducing the premix into a mixer;

(iii) mixing the premix in the mixer for a mixing period, thereby forming a magnesium oxychloride mixture;

(iv) removing the magnesium oxychloride mixture from the mixer and introducing into a holding vessel;

(v) transferring one or more portions of the magnesium oxychloride mixture from the holding vessel onto one or more supports; and

(vi) conveying the one or more supports having the magnesium oxychloride mixture thereon through an oven, wherein the magnesium oxychloride mixture is cured within the oven to form a cementitious construction material comprising magnesium oxychloride crystals, and

(vii) recovering the one or more supports from the oven and removing the cementitious construction material from the one or more supports, and

(viii) forming a production lot of boards from the construction material removed from the one or more supports, wherein:

the production lot of boards comprises a plurality of boards, each of the plurality of boards having an MOC content within about 5% of a target value of MOC content.

Embodiment 51 is the process as set forth in Embodiment 50, wherein the target value of MOC content is between about 60 wt % and about 80 wt %.

Embodiment 52 is the process of any of Embodiments 47 to 51 wherein the production lot of boards is formed at a rate of at least about 45 linear feet/s of board, at least about 50 linear feet/s of boards, or at least about 60 linear feet/s of boards.

Embodiment 53 is the process of any of Embodiments 47 to 52 wherein the production lot is formed over a production time of from about 1 hour to about 4 hours.

Embodiment 54 is a computer-implemented method for mixing elements to prepare a MOC board, wherein said method is performed by a processor, said method comprising:

causing a first pump to place magnesium chloride into a storage tank from a first receptacle;

causing a second pump to move the magnesium chloride from the storage tank to a day tank;

causing a day tank injection element to inject water into the day tank to mix with the magnesium chloride therein;

causing a day tank heating element to heat the water and magnesium chloride in the day tank;

causing a day tank mixing element to mix the water and magnesium chloride in the day tank;

causing a premix pump to pump a mixture of magnesium oxide and calcium carbonate to be placed into a first premix tank;

causing the heated and mixed water and magnesium chloride to be injected from the day tank into the first premix tank;

causing phosphoric acid to be mixed in the first premix tank with the magnesium oxide, the calcium carbonate, water, and magnesium chloride;

causing the elements in the first premix tank to be placed into a main mix tank with a set of dry material additives, water, and siliconate; and

causing a mixer to mix the elements of the mix tank to prepare a MOC base for creation of MOC boards.

Embodiment 55 is a non-transitory machine-readable medium comprising instructions, which when executed by one or more processors, cause the one or more processors to perform the following operations:

cause a first pump to place magnesium chloride into a storage tank from a first receptacle;

cause a second pump to move the magnesium chloride from the storage tank to a day tank;

cause a day tank injection element to inject water into the day tank to mix with the magnesium chloride therein;

cause a day tank heating element to heat the water and magnesium chloride in the day tank;

cause a day tank mixing element to mix the water and magnesium chloride in the day tank;

cause a premix pump to pump a mixture of magnesium oxide and calcium carbonate to be placed into a first premix tank;

cause the heated and mixed water and magnesium chloride to be injected from the day tank into the first premix tank;

cause phosphoric acid to be mixed in the first premix tank with the magnesium oxide, the calcium carbonate, water, and magnesium chloride;

cause the elements in the first premix tank to be placed into a main mix tank with a set of dry material additives, water, and siliconate; and

cause a mixer to mix the elements of the mix tank to prepare a MOC base for creation of MOC boards.

Embodiment 56 is the process of any of one of Embodiments 1 to 53, wherein the construction material is a board characterized by a density of at least about 0.5 g/mL, at least about 0.6 g/mL, at least about 0.7 g/mL, from about 0.5 to about 1.5 g/mL, or from about 0.6 to about 1.4 g/mL.

Embodiment 57 is the process of any of one of Embodiments 1 to 53 or 56, wherein the construction material is a board characterized by a racking strength ranging from 400 pounds per linear foot (“plf”) to 600 plf, determined according to ASTM E72-13A.

Embodiment 58 is the process of any of one of Embodiments 1 to 53, 56, or 57, wherein the construction material is a board characterized by a flexural strength of at least about 5 MPa, at least about 6 MPa, at least about 10 MPa, or at least about 16 MPa.

Embodiment 59 is the process of any of one of Embodiments 1 to 53 or 56 to 58, wherein the construction material is a board characterized by a specific flexural strength of at least about 6 MPa/(g/cm³), at least about 10 MPa/(g/cm³), at least about 15 MPa/(g/cm³), or at least about 20 MPa/(g/cm³)

Embodiment 60 is the process of any of one of Embodiments 1 to 53 or 56 to 59, wherein the construction material is a board characterized by a lateral screw pull thickness of at least about 150 lbf/inch at least about 200 lbf/inch, at least about 250 lbf/inch, at least about 300 lbf/inch, at least about 350 lbf/inch, at least about 400 lbf/inch, at least about 450 lbf/inch, at least about 500 lbf/inch, at least about 550 lbf/inch, or at least about 600 lbf/inch.

Embodiment 61 is the process of any of one of Embodiments 1 to 53 or 56 to 60, wherein the construction material is a board characterized by a specific lateral screw pull thicknesses of at least about 150 lbf/in/(g/cm³), at least about 200 lbf/in/(g/cm³), at least about 250 lbf/in/(g/cm³), at least about 300 lbf/in/(g/cm³), at least about 350 lbf/in/(g/cm³), at least about 400 lbf/in/(g/cm³), at least about 450 lbf/in/(g/cm³), at least about 500 lbf/in/(g/cm³), at least about 550 lbf/in/(g/cm³), at least about 600 lbf/in/(g/cm³), at least about 650 lbf/in/(g/cm³), at least about 700 lbf/in/(g/cm³), at least about 750 lbf/in/(g/cm³), or at least about 800 lbf/inch/(g/cm³).

Embodiment 62 is the process of any of one of Embodiments 1 to 53 or 56 to 61, wherein the construction material is a board characterized by an impact strength demonstrated by no damage as determined by a falling ball (typically having a weight of approximately 532 grams) impact test, using a twelve-inch drop as determined by ASTM D1037.

Embodiment 63 is the process of any of one of Embodiments 1 to 53 or 56 to 62, wherein the construction material is a board characterized by a compression strength (Fc) of at least about 1800 PSI, or a compression strength (Fc) of from about 1800 PSI to about 2200 PSI.

Embodiment 64 is the process of any of one of Embodiments 1 to 53 or 56 to 63, wherein the construction material is a board characterized by a compression indentation depth of less than about 2.5 millimeters (mm) (e.g., less than 1.3 mm or less than about 1 mm) at a pressure least about 1250 PSI, or at a pressure of from about 1500 PSI to about 3000 PSI, as determined by ASTM D2394.

Embodiment 65 is the process of any of one of Embodiments 1 to 53 or 56 to 64, wherein the construction material is a board characterized by a nail head pull through of at least about 90 pounds force (“lbf”), or from about 150 lbf to about 300 lbf, as determined by ASTM D1037.

Embodiment 66 is the process of any of one of Embodiments 1 to 53 or 56 to 65, wherein the construction material is a board characterized by a screw pull through of at least about 175 pounds force (“lbf”), or from about 175 lbf to about 350 lbf, as determined by ASTM D1037.

Embodiment 67 is the process of any of one of Embodiments 1 to 53 or 56 to 66, wherein the construction material is a board characterized by a thermal linear expansion of less than about 0.25%, or from about 0.01% to 0.25%, as determined by ASTM E228.

Embodiment 68 is the process of any of one of Embodiments 1 to 53 or 56 to 67, wherein the construction material is a board characterized by a moisture linear expansion of less than about 0.25%, or from about 0.01% to 0.25%, as determined by ASTM C1185.

Embodiment 69 is the process of any of one of Embodiments 1 to 53 or 56 to 68, wherein the construction material is a board characterized by a moisture stability exhibited by stability in water at about 60° C. for from about 24 hours to about 56 days using the Warm Water Stability Test as authenticated by Clemson University Chemical Engineering Department in 2017.

Embodiment 70 is the process of any of one of Embodiments 1 to 53 or 56 to 69, wherein the construction material is a board characterized by a metal corrosiveness, as evidenced by AWPAE12-94 fastener corrosion testing, measured in mills per year, of 5 mills per year to 30 mills per year, or less than 35 mills per year.

Embodiment 71 is the process of any of one of Embodiments 1 to 53 or 56 to 70, wherein the construction material is a board, wherein the board meets the noncombustibility requirements of ASTM E136 (Standard Test Method for Assessing Combustibility of Materials Using a Vertical Tube Furnace at 750° C., as defined in the 2012, 2015 and 2018 IBC Model Codes).

Embodiment 72 is the process of any of one of Embodiments 1 to 53 or 56 to 71, wherein the construction material is a board characterized by a vapor permeability of about 8 to about 30 Perm.

Embodiment 73 is the process of any of one of Embodiments 1 to 53 or 56 to 72, wherein the construction material is a board characterized by a resistance to seismic impact for earthquakes over 3.1.

Embodiment 74 is the process of any of one of Embodiments 1 to 53 or 56 to 73, wherein the construction material is a board characterized by a seismic rating or force displacement curve that does not include a sharp peak.

Embodiment 75 is the process of any of one of Embodiments 1 to 53 or 56 to 74, wherein the construction material is a board characterized by maintenance of at least about 70% (at least 70%) of strength at a displacement of about 2.5 inches according to ASTM E72.

Embodiment 76 is the process of any of one of Embodiments 1 to 53 or 56 to 75, wherein the construction material is a board characterized by an impact strength demonstrated by no damage as determined by a falling ball (typically having a weight of approximately 532 grams) impact test, using a twelve-inch drop as determined by ASTM D1037.

Embodiment 77 is the process of any of one of Embodiments 1 to 53 or 56 to 76, wherein the construction material is a board characterized by a compression strength (Fc) of at least about 1800 PSI, or a compression strength (Fc) of from about 1800 PSI to about 2200 PSI.

Embodiment 78 is the process of any of one of Embodiments 1 to 53 or 56 to 77, wherein the construction material exhibits a compression indentation depth of less than about 2.5 millimeters (mm) (e.g., less than 1.3 mm or less than about 1 mm) at a pressure least about 1250 PSI, or at a pressure of from about 1500 PSI to about 3000 PSI, as determined by ASTM D2394.

Embodiment 79 is the process of any of one of Embodiments 1 to 53 or 56 to 78, wherein the construction material is a board characterized by a nail head pull through of at least about 90 pounds force (“lbf”), or from about 150 lbf to about 300 lbf, as determined by ASTM D1037.

Embodiment 80 is the process of any of one of Embodiments 1 to 53 or 56 to 79, wherein the construction material is a board characterized by a screw pull through of at least about 175 pounds force (“lbf”), or from about 175 lbf to about 350 lbf, as determined by ASTM D1037.

Embodiment 81 is the process of any of one of Embodiments 1 to 53 or 56 to 80, wherein the construction material is a board characterized by a thermal linear expansion of less than about 0.25%, or from about 0.01% to 0.25%, as determined by ASTM E228.

Embodiment 82 is the process of any of one of Embodiments 1 to 53 or 56 to 81, wherein the construction material is a board characterized by a moisture linear expansion of less than about 0.25%, or from about 0.01% to 0.25%, as determined by ASTM C1185.

Embodiment 83 is the process of any of one of Embodiments 1 to 53 or 56 to 82, wherein the construction material is a board characterized by a moisture stability exhibited by stability in water at about 60° C. for from about 24 hours to about 56 days using the Warm Water Stability Test as authenticated by Clemson University Chemical Engineering Department in 2017.

Embodiment 84 is the process of any of one of Embodiments 1 to 53 or 56 to 83, wherein the construction material is a board characterized by a metal corrosiveness, as evidenced by AWPAE12-94 fastener corrosion testing, measured in mills per year, of 5 mills per year to 30 mills per year, or less than 35 mills per year.

Embodiment 85 is the process of any of one of Embodiments 1 to 53 or 56 to 84, wherein the construction material is a board that meets the noncombustibility requirements of ASTM E136 (Standard Test Method for Assessing Combustibility of Materials Using a Vertical Tube Furnace at 750° C., as defined in the 2012, 2015 and 2018 IBC Model Codes).

Embodiment 86 is the process of any of one of Embodiments 1 to 53 or 56 to 85, wherein the construction material is a board characterized by a vapor permeability of about 8 to about 30 Perm.

Embodiment 87 is the process of any of one of Embodiments 1 to 53 or 56 to 86, wherein the construction material is a board characterized by a resistance to seismic impact for earthquakes over 3.1.

Embodiment 88 is the process of any of one of Embodiments 1 to 53 or 56 to 87, wherein the construction material is a board characterized by a seismic rating or force displacement curve that does not include a sharp peak.

Embodiment 89 is the process of any of one of Embodiments 1 to 53 or 56 to 88, wherein the construction material is a board characterized by maintenance of at least about 70% (at least 70%) of strength at a displacement of about 2.5 inches according to ASTM E72.

Embodiment 90 is a cementitious construction material, wherein the construction material is characterized by one or more of the following properties:

density of at least about 0.5 g/mL, at least about 0.6 g/mL, at least about 0.7 g/mL, from about 0.5 to about 1.5 g/mL, or from about 0.6 to about 1.4 g/m; and/or

racking strength ranging from 400 pounds per linear foot (“plf”) to 600 plf, determined according to ASTM E72-13A; and/or

flexural strength of at least about 5 MPa, at least about 6 MPa, at least about 10 MPa, or at least about 16 MPa; and/or

specific flexural strength of at least about 6 MPa/(g/cm³), at least about 10 MPa/(g/cm³), at least about 15 MPa/(g/cm³), or at least about 20 MPa/(g/cm³); and/or

lateral screw pull thickness of at least about 150 lbf/inch at least about 200 lbf/inch, at least about 250 lbf/inch, at least about 300 lbf/inch, at least about 350 lbf/inch, at least about 400 lbf/inch, at least about 450 lbf/inch, at least about 500 lbf/inch, at least about 550 lbf/inch, or at least about 600 lbf/inch; and/or

specific lateral screw pull thicknesses of at least about 150 lbf/in/(g/cm³), at least about 200 lbf/in/(g/cm³), at least about 250 lbf/in/(g/cm³), at least about 300 lbf/in/(g/cm³), at least about 350 lbf/in/(g/cm³), at least about 400 lbf/in/(g/cm³), at least about 450 lbf/in/(g/cm³), at least about 500 lbf/in/(g/cm³), at least about 550 lbf/in/(g/cm³), at least about 600 lbf/in/(g/cm³), at least about 650 lbf/in/(g/cm³), at least about 700 lbf/in/(g/cm³), at least about 750 lbf/in/(g/cm³), or at least about 800 lbf/inch/(g/cm³); and/or

an impact strength demonstrated by no damage as determined by a falling ball (typically having a weight of approximately 532 grams) impact test, using a twelve-inch drop as determined by ASTM D1037; and/or

a compression strength (Fc) of at least about 1800 PSI, or a compression strength (Fc) of from about 1800 PSI to about 2200 PSI; and/or

a compression indentation depth of less than about 2.5 millimeters (mm) (e.g., less than 1.3 mm or less than about 1 mm) at a pressure least about 1250 PSI, or at a pressure of from about 1500 PSI to about 3000 PSI, as determined by ASTM D2394; and/or

a nail head pull through of at least about 90 pounds force (“lbf”), or from about 150 lbf to about 300 lbf, as determined by ASTM D1037; and/or

a screw pull through of at least about 175 pounds force (“lbf”), or from about 175 lbf to about 350 lbf, as determined by ASTM D1037; and/or

a thermal linear expansion of less than about 0.25%, or from about 0.01% to 0.25%, as determined by ASTM E228; and/or

moisture linear expansion of less than about 0.25%, or from about 0.01% to 0.25%, as determined by ASTM C1185; and/or

a moisture stability exhibited by stability in water at about 60° C. for from about 24 hours to about 56 days using the Warm Water Stability Test as authenticated by Clemson University Chemical Engineering Department in 2017; and/or

a metal corrosiveness, as evidenced by AWPAE12-94 fastener corrosion testing, measured in mills per year, of 5 mills per year to 30 mills per year, or less than 35 mills per year; and/or

meeting the noncombustibility requirements of ASTM E136 (Standard Test Method for Assessing Combustibility of Materials Using a Vertical Tube Furnace at 750° C., as defined in the 2012, 2015 and 2018 IBC Model Codes); and/or

a vapor permeability of about 8 to about 30 Perm; and/or

a resistance to seismic impact for earthquakes over 3.1; and/or

a seismic rating or force displacement curve that does not include a sharp peak; and/or.

maintenance of at least about 70% (at least 70%) of strength at a displacement of about 2.5 inches according to ASTM E72.

Embodiment 91 is the cementitious construction material of Embodiment 90, wherein the construction material is a board.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above without departing from the scope of the invention, it is intended that all matter contained in the above description and shown in the accompanying drawing[s] shall be interpreted as illustrative and not in a limiting sense.

1. A process for making a magnesium oxychloride cementitious construction material, the process comprising:
forming a magnesium oxychloride concrete mixture into a plurality of boards on a plurality of supports;
conveying the plurality of supports with the boards thereon through a curing oven, the curing oven comprising an entrance, an exit and a plurality of curing zones therebetween through which the supports with the boards thereon are conveyed, each curing zone having one or more curing air inlets and one or more curing air outlets through which curing air is circulated in contact with the boards when conveyed through the zone, wherein as the boards are conveyed through the curing zones, the magnesium oxychloride mixture of the boards is cured to form the magnesium oxychloride cementitious construction material comprising magnesium oxychloride crystals and generate exothermic heat within one or more of the curing zones; and
transferring at least a portion of the exothermic heat generated in one or more of the curing zones to one or more curing zones upstream of the one or more of the curing zones from which the exothermic heat is transferred.

2. The process of claim 1, wherein curing air heated by the exothermic heat generated during curing of the magnesium oxychloride mixture in one or more of the plurality of curing zones is withdrawn from the curing oven and introduced into one or more of the upstream curing zones.

3. A process for making a magnesium oxychloride cementitious construction material, the process comprising:
forming a magnesium oxychloride concrete mixture into a plurality of boards on a plurality of supports;
conveying the plurality of supports with the boards thereon through a curing oven, the curing oven comprising an entrance, an exit and a plurality of curing zones therebetween through which the supports with the boards thereon are conveyed, each curing zone having one or more curing air inlets and one or more curing air outlets through which curing air is circulated in contact with the boards when conveyed through the zone, wherein as the boards are conveyed through the curing zones the magnesium oxychloride mixture of the boards is cured to form the magnesium oxychloride cementitious construction material comprising magnesium oxychloride crystals and the time required for each board to pass through the curing oven and the temperature and humidity of the curing air are controlled such that boards exiting the curing oven:
comprise 5-phase magnesium oxychloride having the formula Mg₃(OH)₅Cl.4H₂O in a concentration of at least about 65 wt %, at least about 70 wt %, at least about 72 wt %, at least about 74 wt %, at least about 76 wt %, at least about 78 wt %, at least about 80 wt %, at least about 82 wt %, at least about 84 wt %, at least about 86 wt %, at least about 88 wt %, or at least about 90 wt %, as determined by X-Ray Diffraction (XRD); and/or
exhibit a flexural strength of at least about 5 MPa, at least about 6 MPa, at least about 10 MPa, or at least about 16 MPa; and/or
a specific flexural strength of at least about 6 MPa/(g/cm³), at least about 10 MPa/(g/cm³), at least about 15 MPa/(g/cm³), or at least about 20 MPa/(g/cm³).

4. The process of claim 1, further comprising:
mixing and reacting a source of magnesium chloride brine with a source of magnesium oxide in a premixer, thereby forming a magnesium oxychloride cement premix;
transferring the magnesium oxychloride cement premix to a mixer; and
mixing the magnesium oxychloride cement premix with an aggregate in the mixer, thereby forming the magnesium oxychloride concrete mixture.

5. A process for making a magnesium oxychloride cementitious construction material, the process comprising:
mixing and reacting a source of magnesium chloride brine with a source of magnesium oxide in a premixer, thereby forming a magnesium oxychloride cement premix;
transferring the magnesium oxychloride cement premix to a mixer;
mixing the magnesium oxychloride cement premix with an aggregate in the mixer, thereby forming a magnesium oxychloride concrete mixture;
continuously forming the magnesium oxychloride concrete mixture into a planar mass of the desired dimensions for board production onto a plurality of supports and cutting the planar mass into boards of the desired length; and
continuously conveying the supports with the boards thereon through a curing oven, the curing oven comprising an entrance, an exit and a plurality of curing zones therebetween through which the supports with the boards thereon are conveyed, each curing zone having one or more curing air inlets and one or more curing air outlets through which curing air is circulated in contact with the boards when conveyed through the zone, wherein as the boards are conveyed through the curing zones, the magnesium oxychloride mixture of the boards is cured to form the magnesium oxychloride cementitious construction material comprising magnesium oxychloride crystals.

6. (canceled)

7. The process of claim 1, wherein the curing air comprises humidified ambient air to increase the humidity of the curing air introduced into each curing zone.

8. (canceled)

9. The process of claim 4, wherein the temperature of the magnesium chloride brine is controlled to regulate the temperature of the formed plurality of boards conveyed into the first curing zone adjacent the entrance to the curing oven.

10. The process of claim 1, wherein prior to forming the magnesium oxychloride concrete mixture into the plurality of boards, the magnesium oxychloride concrete mixture is retained in a holding vessel, and forming the magnesium oxychloride concrete mixture into the plurality of boards comprises extruding the mixture from the holding vessel onto a layer of material to be incorporated into the magnesium oxychloride cementitious construction material and carried by the supports.

11. The process of claim 10, wherein the temperature within the first curing zone adjacent the entrance of the curing oven is no more than about 50° C. (about 120° F.) greater than the temperature of the magnesium oxychloride mixture retained in the holding vessel.

12. The process of claim 10, wherein the temperature within the first curing zone adjacent the entrance of the curing oven is no more than about 20° C. (about 68° F.) greater than the temperature of the magnesium oxychloride mixture retained in the holding vessel.

13. The process of claim 4, the process further comprising:
monitoring the temperature of the magnesium oxychloride cement premix formed in the premixer;
comparing the temperature of the magnesium oxychloride cement premix formed in the premixer to a desired temperature; and
adjusting the temperature of the magnesium oxychloride cement premix.

14. (canceled)

15. (canceled)

16. The process of claim 4 wherein the temperature of the magnesium chloride brine is from about 10° C. (about 50° F.) to about 40° C. (about 105° F.).

17. The process of claim 4 wherein the density of the magnesium chloride brine is at least about 1.20 g/mL.

18. (canceled)

19. The process of claim 4, wherein the density of the magnesium chloride brine is adjusted in response to a deviation in the temperature of the magnesium oxychloride mixture from the desired temperature.

20. (canceled)

21. (canceled)

22. The process of claim 4, wherein the premix contains magnesium oxide (MgO), magnesium chloride (MgCl₂) and water (H₂O), on an active ingredient basis, at a molar ratio of at least about 5.1:1:13.

23. The process of claim 4 wherein the aggregate comprises one or more materials selected from wood fiber, perlite, polystyrene foam beads, carbon fiber, glass fiber, polymer fiber, natural fiber, and calcium carbonate powder.

24. The process of claim 4, the process further comprising introducing phosphorous acid (H₃PO₃) and/or phosphoric acid (H₃PO₄) into the magnesium oxychloride cement premix prior to its transfer to the mixer.

25. The process of claim 1, wherein the plurality of supports having the boards thereon are supported horizontally on a rack and spaced vertically from one another such that no support is in contact with another support of the plurality of supports; and wherein the rack is conveyed along a path from the entrance of the curing oven to the exit of the curing oven through the plurality of curing zones along the path.

26. The process of claim 25, wherein the one or more curing air inlets in each curing zone is arranged at substantially the same elevation of each support with the board thereon, such that the flow of curing air introduced through the one or more curing air inlets is substantially parallel to the horizontal surface of each of the boards as the rack passes through the curing zone.

27. The process of claim 4 wherein:
the density of the magnesium chloride brine is maintained at a target value of from about 1.15 g/mL to about 1.30 g/mL; and/or
the source of magnesium oxide has a BET surface area of from about 10 m²/g to about 120 m²/g; and/or
the plurality of boards cured to form the cementitious construction material comprising magnesium oxychloride crystals passes through the exit of the curing oven at a rate of greater than about 20 linear feet/s; about and/or
the relative humidity within each of the plurality of curing zones is continuously monitored and optionally adjusted if necessary to maintain the humidity within a desired range.

28-30 (canceled)
